(19) United States
(12) Patent Application Publication
(10) Pub. No.: US 2025/0199314 A1
(43) Pub. Date: Jun. 19, 2025

(54) HEAD-WEARABLE DEVICE DISPARITY SENSING AND DISPARITY CORRECTION, AND SYSTEMS AND METHODS OF USE THEREOF

(71) Applicant: Meta Platforms Technologies, LLC, Menlo Park, CA (US)

(72) Inventors: Saara Khan, Cupertino, CA (US); Igor Markovsky, Campbell, CA (US); Helia Rahmani, Mountain View, CA (US); Michiel Koen Callens, Mountain View, CA (US); Tony David, San Jose, CA (US); Stephen McClure, San Carlos, CA (US)

(21) Appl. No.: 18/972,711

(22) Filed: Dec. 6, 2024

Related U.S. Application Data
(60) Provisional application No. 63/612,306, filed on Dec. 19, 2023.

(51) Int. Cl. G02B 27/01; G02B 27/00

(52) U.S. Cl. CPC G02B 27/0172; G02B 27/0093; G02B 2027/011; G02B 2027/0134; G02B 2027/014; G02B 2027/0178

(57) ABSTRACT

Systems and methods of calibrating a head-wearable device are disclosed. An example method includes, while a position of an artificial-reality glasses relative to a storage device satisfies position criteria, causing the artificial-reality glasses to display calibration patterns using a lens assemblies of the artificial-reality glasses, and capturing, using an imaging device communicatively coupled to the storage device and associated with the lens assemblies, calibration images of the calibration patterns displayed using the lens assemblies of the artificial-reality glasses. The method further includes, in accordance with a determination, based on the calibration images, that an amount of disparity between the respective calibration patterns displayed using the lens assemblies satisfies calibration criteria, causing the artificial-reality glasses to apply, based on the amount of disparity, a disparity correction to one or more of the lens assemblies.

### CROSS-REFERENCE TO RELATED APPLICATIONS

This application claims priority to U.S. Prov. Patent App. No. 63/612,306, filed Dec. 19, 2023, entitled “Head-Wearable Device Disparity Sensing and Disparity Correction, and Systems and Methods of Use Thereof,” which is hereby fully incorporated by reference in its entirety.

### TECHNICAL FIELD

This relates generally to calibrating displays of a head-wearable device, including but not limited to techniques for online and offline disparity correction of one or more displays (e.g., lens assemblies including display projector assemblies) of the head-wearable device.

### BACKGROUND

Artificial-reality headsets are more accessible and are used to provide users with a richer, more engaging user experience. However, when artificial-reality headsets are used for extended periods of time and/or when the artificial-reality headsets are deformed, the data presented by the displays of the artificial-reality headsets can be distorted. The distortion is due to disparity at the displays of the artificial-reality headsets. Existing solutions to correct the disparity in the displays of the artificial-reality headsets can be expensive and require extensive down time.

As such, there is a need to address one or more of the above-identified challenges. A brief summary of solutions to the issues noted above are described below.

### SUMMARY

The methods, systems, and devices described herein allow for online and offline disparity correction of a head-wearable device. Specifically, the methods, systems, and devices correct disparity of a head-wearable device while the head-wearable device is not in use (e.g., while the head-wearable device is charging or stored within a case) and/or while the head-wearable device is in use. The methods, systems, and devices described herein provide a low-cost solution for correcting disparity that is not available in existing solutions.

One example of an artificial-reality headset is described herein. While certain references are made to an artificial-reality headset, for the purposes of this disclosure, the terms artificial-reality headset and artificial-reality glasses are used interchangeably. This example artificial-reality headset is communicatively coupled with a storage device and includes one or more cameras, one or more displays (e.g., placed behind one or more lenses and/or part of a display assembly), and one or more programs, where the one or more programs are stored in memory and configured to be executed by one or more processors. The one or more programs including instructions for performing operations. The operations include, while a position of the artificial-reality headset relative to the storage device satisfies relative position criteria, i) causing the artificial-reality headset to display one or more calibration patterns using a first lens assembly and a second lens assembly of the artificial-reality headset, and ii) capturing using the one or more imaging devices coupled to the storage device and associated with the first lens assembly and the second lens assembly, one or more calibration images of the one or more calibration patterns displayed using the first lens assembly and the second lens assembly of the artificial-reality headset. The operations further include, in accordance with a determination, based on the one or more calibration images, that an amount of disparity between the respective calibration patterns displayed using the first lens assembly and the second lens assembly satisfies calibration criteria causing the artificial-reality headset to apply, based on the amount of disparity, a disparity correction to one or both of the first lens assembly and the second lens assembly.

Having summarized a first aspect generally related to a head-wearable device for performing disparity correction, a second aspect (generally related to a storage device for performing disparity correction) is now summarized.

In another example, a storage device is described herein. This example storage device is communicatively coupled with an artificial-reality headset that includes one or more cameras, one or more displays (e.g., placed behind one or more lenses and/or part of a display assembly). The storage device includes one or more programs stored in memory and configured to be executed by one or more processors. The one or more programs including instructions for performing operations. The operations include, while a position of the artificial-reality headset relative to the storage device satisfies relative position criteria, i) causing the artificial-reality headset to display one or more calibration patterns using a first lens assembly and a second lens assembly of the artificial-reality headset, and ii) capturing using the one or more imaging devices coupled to the storage device and associated with the first lens assembly and the second lens assembly, one or more calibration images of the one or more calibration patterns displayed using the first lens assembly and the second lens assembly of the artificial-reality headset. The operations further include, in accordance with a determination, based on the one or more calibration images, that an amount of disparity between the respective calibration patterns displayed using the first lens assembly and the second lens assembly satisfies calibration criteria causing the artificial-reality headset to apply, based on the amount of disparity, a disparity correction to one or both of the first lens assembly and the second lens assembly.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A and 1B illustrate a case for calibrating artificial-reality glasses, in accordance with some embodiments.

FIG. 2 illustrates example disparity detection using a case for calibrating artificial-reality glasses, in accordance with some embodiments.

FIG. 3 illustrates a visual representation of a horizontal disparity error in artificial-reality glasses, in accordance with some embodiments.

FIGS. 4A and 4B illustrate manifestation of a disparity error in artificial-reality glasses, in accordance with some embodiments.

FIGS. 5A-5E illustrates an example stress applied to artificial-reality glasses and associated disparity error, in accordance with some embodiments.

FIG. 6 illustrates another case for calibrating artificial-reality glasses, in accordance with some embodiments.

FIG. 7 illustrates yet another case for calibrating artificial-reality glasses, in accordance with some embodiments.

FIG. 8 illustrates a flow diagram of a method of disparity correction, in accordance with some embodiments.

FIGS. 9A-9C-2 illustrate example artificial-reality systems, in accordance with some embodiments.

FIGS. 10A-10B illustrate an example wrist-wearable device, in accordance with some embodiments.

FIGS. 11A-11C illustrate example head-wearable devices, in accordance with some embodiments.

FIGS. 12A-12B illustrate an example handheld intermediary processing device, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

Embodiments of this disclosure can include or be implemented in conjunction with various types or embodiments of artificial-reality systems. Artificial-reality (AR), as described herein, is any superimposed functionality and or sensory-detectable presentation provided by an artificial-reality system within a user's physical surroundings. Such artificial-realities can include and/or represent virtual reality (VR), augmented reality, mixed artificial-reality (MAR), or some combination and/or variation one of these. For example, a user can perform a swiping in-air hand gesture to cause a song to be skipped by a song-providing API providing playback at, for example, a home speaker. An AR environment, as described herein, includes, but is not limited to, VR environments (including non-immersive, semi-immersive, and fully immersive VR environments); augmented-reality environments (including marker-based augmented-reality environments, markerless augmented-reality environments, location-based augmented-reality environments, and projection-based augmented-reality environments); hybrid reality; and other types of mixed-reality environments.

Artificial-reality content can include completely generated content or generated content combined with captured (e.g., real-world) content. The artificial-reality content can include video, audio, haptic events, or some combination thereof, any of which can be presented in a single channel or in multiple channels (such as stereo video that produces a three-dimensional effect to a viewer). Additionally, in some embodiments, artificial reality can also be associated with applications, products, accessories, services, or some combination thereof, which are used, for example, to create content in an artificial reality and/or are otherwise used in (e.g., to perform activities in) an artificial reality.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMU) s of a wrist-wearable device) and/or detected via image data captured by an imaging device of a wearable device (e.g., a camera of a head-wearable device)) or a combination of the user's hands. In-air means, in some embodiments, that the user hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single or double finger tap on a table, on a user's hand or another finger, on the user's leg, a couch, a steering wheel, etc.). The different hand gestures disclosed herein can be detected using image data and/or sensor data (e.g., neuromuscular signals sensed by one or more biopotential sensors (e.g., EMG sensors) or other types of data from other sensors, such as proximity sensors, time-of-flight (ToF) sensors, sensors of an inertial measurement unit, etc.) detected by a wearable device worn by the user and/or other electronic devices in the user's possession (e.g., smartphones, laptops, imaging devices, intermediary devices, and/or other devices described herein).

As described herein, disparity, in some embodiments, can be understood as computer vision with pixel disparity between two images (e.g., a left image and right image). A head-wearable device can have particular disparity specification of arcminutes. For example, in some embodiments, a head-wearable device can have a disparity specification of 12 arcmin (3.5 mm at 1.5 m). When the disparity of a head-wearable device is set at 12 arcmin, the maximum horizontal separation between the corresponding points in the left and right images is 12 arcminutes (a unit of angular measurement), which is equivalent to a physical horizontal separation of 3.5 mm at a viewing distance of 1.5 m. An arcminute, as described herein, is 1/60th of a degree (e.g., such that 12 arcmins equals 0.2 degrees).

A head-wearable device's disparity specification of arcminutes can be translated into pixel disparity between images. The translation includes i) obtaining a horizontal field of view (HFOV) and vertical field of view (VFOV)-in degrees-of a communicatively coupled display; ii) calculating a horizontal angular resolution for the communicatively coupled display; and iii) calculating pixel disparity. The horizontal angular resolution for the communicatively coupled display is determined by dividing a horizontal resolution (number of pixels) of the communicatively coupled display by the HFOV of the communicatively coupled display (which provides pixels per degree). The pixel disparity is determined by multiplying the disparity in arcmin (e.g., a predetermined arcmin) by the calculated horizontal angular resolution. As there are 60 arcmin in a degree, the predetermined arcmin can be converted to predetermined degrees (e.g.,

$$\frac{predetermined arc min}{60} = predetermined degrees$$

More specifically, the pixel disparity can be determined by the following formula:

$$Pixel Disparity = Disparity in Degrees \times \frac{P i x e l s}{D e g r e e}$$

The above-example equations can be applied for determining vertical angular resolution (e.g., dividing a vertical resolution (number of pixels) of the communicatively coupled display by the VFOV of the communicatively coupled display) and the associated pixel disparity.

Binocular disparity (disparity at a head-wearable device presenting images via a display of each lens) can be described in individual components including vertical, horizontal, and rotational components. Binocular disparity can be caused by one or more stresses experienced at a system (e.g., head-wearable device) including, but not limited to, thermal stresses, mechanical stresses, and lifetime stresses. Thermal stresses can be based on system usage (e.g., due to operation of one or more processors and/or activation of one or more displays) and solar radiation at the system that result in increased temperatures inside and across a body of the system and induce a change to the body of the system (e.g., warpage, elongation, etc. of frames and/or temple arms of a head-wearable device). Mechanical stresses can be a result of donning and/or doffing a system (e.g., based on different head sizes), which can cause the frames and/or temple arms of a head-wearable device to substantially warp, elongate, etc. when a user wears the head-wearable device. Mechanical stresses can also be due to regular use of the system (e.g., everyday bending, torsion, warpage, and axial changes to the frames and/or temple arms of a head-wearable device). Lifetime stresses are due to stresses experience by a system over weeks, months, years, etc. For example, lifetime stresses can include normal wear-and-tear, frame and/or temple arm warpage, high and/or low temperature exposure (e.g., head-wearable device left within a hot vehicle), and/or other stresses experienced during the life of the system.

Binocular disparity, if not corrected, can result in vertical disparity, convergent horizontal disparity, and/or divergent horizontal disparity. Vertical disparity can cause binocular rivalry (e.g., presentation of mutually incongruent images to the left and the right eye) and double vision after short periods of exposure to large periods of exposure (e.g., where small amounts of vertical disparity can induce eye strain, headaches, and discomfort after longer periods of exposure). Convergent horizontal disparity can cause depth perception errors—where small amounts of depth perception errors cause content to appear to swim as a user of a head-wearable device orbits around the content and large amounts of depth perception errors cause a “dollhouse effect” where virtual content appears to be a miniaturized model of what is being presented. Divergent horizontal disparity can have similar effects to vertical disparity as the human visual system cannot comfortably diverge the left and right eyes to fuse images.

The systems and method disclosed herein can perform disparity correction while a head-wearable device is offline or online. A determination to perform offline or online disparity correction is based on product use-cases and/or use-cases that increased disparity errors. For example, offline disparity correction can be appropriate when a device does not include disparity sensing mechanism (e.g., sensors for detecting disparity). Online disparity correction can be appropriate when a device experiences disparity during use of the device (e.g., warping caused when a head-wearable device is placed on a user's head. Offline disparity correction can be used to supplement online disparity correction (e.g., online sensor fusion pixel correction) on the head-wearable device. Alternatively, or in addition, offline disparity correction can be used as a replacement for online disparity correction (e.g., when a head-wearable device does not include a disparity sensing mechanism that can be used when a display is in use).

The determination to perform offline or online disparity correction can also be based on the type of device. For example, artificial-reality glasses (including augmented-reality glasses) can be active for extended periods of time—which increases the thermal stress of the artificial-reality glasses and induces disparity while the artificial-reality glasses are in-use—and require high accuracy online calibration (e.g., disparity correction via a mini-waveguide approach) for detected in-use deformation and/or detected in-use disparity. Alternatively, smart glasses can be active intermittently and/or for short periods of time and do not require high accuracy online calibration. Smart glasses can use an on-the-go charging case to perform offline disparity correction (e.g., while the smart glasses are charging within the on-the-go charging case) and/or a lower-resolution sensor fusion technique to correct for additive disparity errors while the smart glasses are used throughout the day. The above hybrid approach for disparity correction applied at smart glasses can be used to correct disparity errors unless severe. If severe disparity errors are present, alternative disparity error correction techniques would need to be applied.

In some embodiments, the disparity corrections systems and methods disclosed herein are configured to correct disparity caused due to chassis twist, mini-waveguide (WG) rigid body motion, projector optical boresight error, camera lens boresight error, main WG rigid body motion, projector rigid body motion (e.g., glue expansion), disparity sensor to chassis. In some embodiments, the disparity corrections systems and methods disclosed herein can correct harder to detect disparity errors such as main WG warp (horizontal), main WG warp, dynamic distortion correction error, display lens error (e.g., errors in a lens assembly and/or associated display projector assembly), display to display calibration error, WG pupil swim, mini WG twist, and/or calibration error (factory vs online).

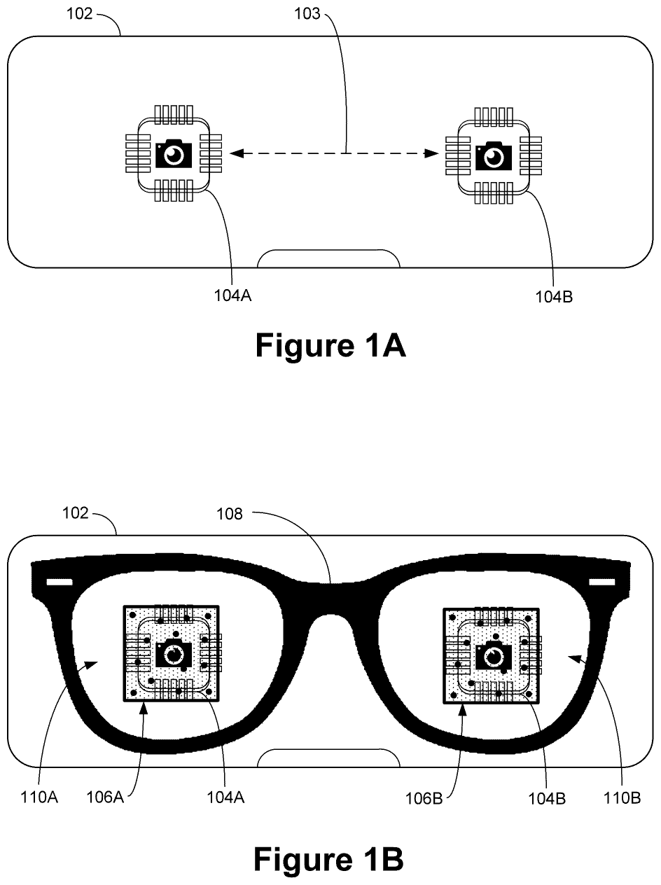

FIGS. 1A and 1B illustrate a case for calibrating artificial-reality glasses, in accordance with some embodiments. Specifically, FIGS. 1A and 1B show a case 102 (e.g., a carrying case, charging case, and/or other storage device.) configured to perform offline disparity correction at a head-wearable device 108. The case 102 and the head-wearable device 108 are communicatively coupled and are configured to coordinate the disparity correction as discussed below. The case 102 includes at least two imaging devices 104. The at least two imaging devices 104 can be (cost-efficient) cameras (e.g., a stereo camera module). In some embodiments, the at least two imaging devices 104 are red-blue-green cameras, ultra-wide-angle cameras, wide-angle cameras, fish-eye cameras, spherical cameras, telephoto cameras, a depth-sensing cameras, or other types of cameras. In some embodiments, the at least two imaging devices 104 are integrated into the backplane of the case 102.

The at least two imaging devices 104 are separated by a baseline distance 103. The baseline distance 103 is configured to approximately match the center eye-box location of the binocular display location of the head-wearable device 108. For purposes of this disclosure, in some embodiments, an eyebox location (e.g., represented respective outlines around calibration patterns 106) of a particular lens assembly 110 is a location on the particular lens assembly 110 where a user's eyes would be to view a display (or presented representation of data). For example, as shown in FIGS. 1A and 1B, a first imaging device 104A is separated from a second imaging device 104B by the baseline distance 103 and each optical element 104 is aligned with a respective eyebox of a lens assembly 110. In some embodiments, the baseline distance 103 is a center-to-center distance between the respective eyebox locations of a first lens assembly 110A and a second lens assembly 110B (which, as shown in FIG. 1B, are at the center portion of the lens assemblies 110).

A first imaging device 104A of the one or more imaging devices 104 is configured to capture the one or more calibration patterns (e.g., first calibration pattern 106A) displayed using the first lens assembly 110A and a second imaging device 104B of the one or more imaging devices 104 is configured to capture one or more calibration patterns (e.g., second calibration pattern 106B) displayed using the second lens assembly 110b. The first imaging device 104A is positioned at a first region associated with the first lens assembly 110A (e.g., at an approximate location (e.g. +/−0.03 mm) of an eyebox of the first lens assembly 110A (e.g., near a center region of the lens)) and the second imaging device 104B is positioned at a second region associated of the second lens assembly 110B (e.g., at an approximate location of an eyebox of the second lens assembly 110B (e.g., near a center region of the lens)).

The first region and the second region are a predefined distance apart (e.g., the baseline distance 103). In some embodiments, the predefined distance includes a distance within an interpupillary distance range associated with the artificial-reality headset, and the first region and the second region are located proximate to a focal point associated with the first lens assembly and the second lens assembly, respectively.

As shown in FIG. 1B, the head-wearable device 108 is positioned above a position of the case 102 including the at least two imaging devices 104. While a position of the head-wearable device 108 relative to the case 102 satisfies relative position criteria, the head-wearable device 108 is caused to display one or more calibration patterns 106 using the first lens assembly 110A and the second lens assembly 110B, and the case 102 is caused to capture, using the first imaging device 104A and the second imaging device 104B, one or more calibration images of the one or more calibration patterns 106 displayed using the first lens assembly 110A and the second lens assembly 110B. In other words, in accordance with a determination that the relative position criteria is satisfied, the head-wearable device 108 activates its one or more displays (e.g., turns on the first lens assembly 110A and the second lens assembly 110B) such that the first lens assembly 110A and the second lens assembly 110B of the head-wearable device 108 remain active during the calibration process (which causes the presentation of respective calibration patterns 106), and, while the first lens assembly 110A and the second lens assembly 110B present respective calibration patterns 106, the first imaging device 104A and the second imaging device 104B capture image data representative of the respective calibration patterns 106.

In some embodiments, the relative position criteria include a first relative position criteria that includes the head-wearable device 108 being a substantially zero distance from the case 102 (e.g., the head-wearable device 108 disposed directly above a position of the case 102 including the at least two imaging devices 104). In some embodiments, the positioning criteria includes the head-wearable device 102 mechanically and/or electrically coupling to the charging contacts and/or mounts of the case 102 (e.g., such that the head-wearable device 108 is a substantially zero distance from the case 102). In some embodiments, the positioning criteria include the case 102 being completely closed with the head-wearable device 108 inside the case 102. In some embodiments, the case 102 includes a mold to guide the head-wearable device 108 into the correct location. Alternatively, or in addition, in some embodiments, the relative position criteria include a second relative position criteria that includes the head-wearable device 108 being a substantially non-zero distance from the case 102 (e.g., online disparity correction while the head-wearable device 108 is worn by a user and not within the case 102 and/or not disposed above the at least two imaging devices 104).

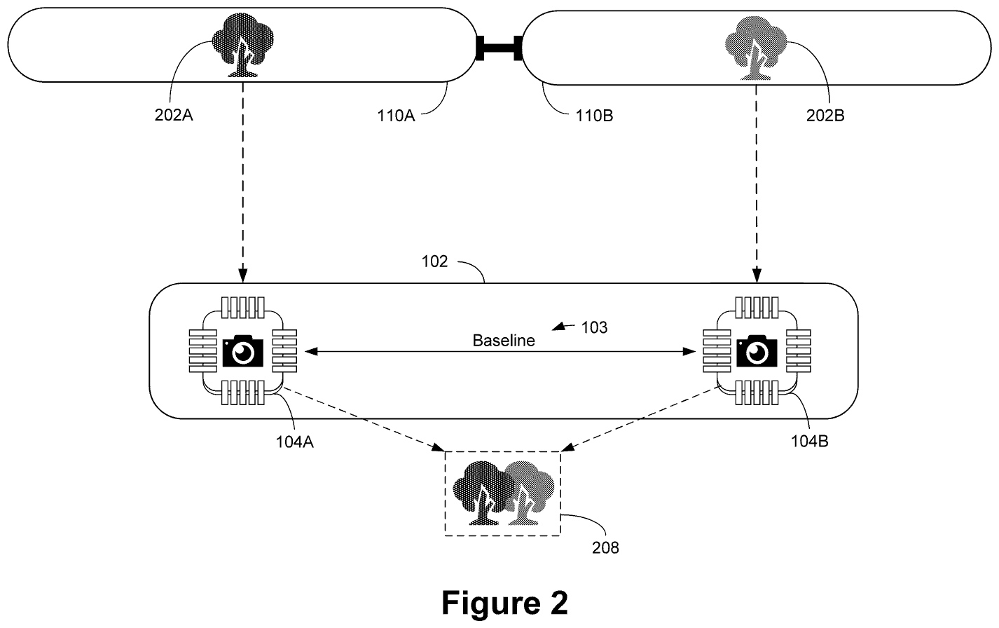

FIG. 2 illustrates example disparity detection using a case for calibrating artificial-reality glasses, in accordance with some embodiments. Specifically, FIG. 2 is a side view of the FIGS. 1A and 1B and show the imaging devices 104 housed within a bottom portion of the case 102 and positioned below the head-wearable device 108. In this way, the imaging devices 104 operate as a virtual pair of eyes (behind the head-wearable device 108) that view calibration patterns 202 presented by the lens assemblies 110, and the image data captured by the imaging devices 104 can detect disparity (e.g., disparity as viewed through a user's eyes). As mentioned above, during the calibration process the first lens assembly 110A and the second lens assembly 110B cause presentation of respective calibration patterns 202 (e.g., analogous to calibration patterns 106; FIGS. 1A and 1B) and the one or more imaging devices 104 of the case 102 capture one or more calibration images of the one or more calibration patterns displayed using the first lens assembly 110A and the second lens assembly 110B. For example, the first imaging device 104A captures a representation of a first calibration pattern 202A and the second imaging device 104B captures a representation of a second calibration pattern 202B.

The case 102 and/or the head-wearable device 102 determine, based on the one or more calibration images, an amount of disparity between the respective calibration patterns displayed using the first lens assembly 110A and the second lens assembly 110B. The case 102 and/or the head-wearable device 102, based on a determination that the amount of disparity between the respective calibration patterns satisfies calibration criteria, cause the head-wearable device 108 to apply, based on the amount of disparity, a disparity correction to one or both of the first lens assembly 110A and the second lens assembly 110B. In other words, the respective image data captured by the first imaging device 104A and the second imaging device 104B is used to correct the disparity in head-wearable device 108. In some embodiments, the disparity is measured in angles and/or distances. For example, the disparity can be measured in millimeters between two points in the one or more calibration images and/or arcmins between the two points in the one or more calibration images.

The disparity in the head-wearable device 108 can include vertical disparity, convergent vertical disparity, divergent horizontal disparity, and/or other disparity described above. Different amounts of disparity can be acceptable depending on the exposure time. For example, for short-term exposure, acceptable vertical binocular disparity can be 10 arcmin and acceptable horizontal binocular disparity can be 7 arcmin. Alternatively, for long-term exposure, acceptable vertical binocular disparity can be 5 arcmin and acceptable horizontal binocular disparity can be 5 arcmin. The disparity correction methods discussed below are configured to operate the head-wearable device at or below the short-term exposure and long-term exposure acceptable ranges.

Disparity correction can be performed by modifying how the hardware of the head-wearable device 108 operates. For example, each lens assembly 110 can include a display projector assembly configured to cause presentation of data and operation of the display projector assembly can be adjusted for disparity correction. In some embodiments, the one or more calibration patterns 202 are presented using a display projector assembly (e.g., a liquid crystal on silicon projector (LCoS)) associated with a lens assembly 110 and the display projector assembly can be adjusted to perform disparity correction. For example, applying the disparity correction to one or both of the first lens assembly 110A and the second lens assembly 110B, based on the amount of disparity, can include causing the head-wearable device 108 to modify a first image projection (e.g., the first calibration pattern 202A) from a first display projector assembly associated with the first lens assembly 110A and/or a second image projection (e.g., the second calibration pattern 202B) from a second project assembly associated with the second lens assembly 110B to reduce the amount of disparity.

Alternatively, or in addition, in some embodiments, applying a disparity correction to one or both of the first lens assembly 110A and the second lens assembly 110B includes causing the head-wearable device 108 adjust the one or more images prior to displaying the one or more images using the first lens assembly 110A and/or the second lens assembly 110B. In other words, the data that is to be presented to a user can be modified or adjusted before being displayed such that the modified data corrects detected disparity errors. Non-limiting examples of the modifications or adjustments to the data before it is presented include magnification, reduction, rotation, shifting, recoloring, and/or other image transformations. For example, the image data presented using the first lens assembly 110A can be magnified to match a size of the image data presented using the second lens assembly 110B.

The calibration images captured by the imaging devices 104 can be used accurately detect sources of disparity error that are not detectable with existing methods and systems. Specifically, the imaging devices 104 can be red-green-blue (RGB) cameras allow for the capture and measure of additional light signals (e.g., more than one light wavelength) from the data presented in an eyebox. By allowing for the measure of additional wavelengths of light the disparity corrections systems and methods disclosed herein are able to detect sources of disparity error that are not detectable using traditional methods (e.g., that use a single wavelength). Additionally, by allowing for the measure of additional wavelengths of light the disparity corrections systems and methods disclosed herein, can be used to color-correct the display (e.g., a display projector assembly) of a respective lens assembly 110, as well as correct calibration errors that are not found or present during manufacturing. For example, the one or more calibration images can be used to determine an amount of color disparity between the one or more captured calibration images and the respective calibration patterns and, in accordance with a determination that the amount of color satisfies color calibration criteria, the case 102 and/or the head-wearable device 108 apply, based on the amount of color disparity, a color disparity correction to one or both of the first lens assembly 110A and the second lens assembly 110B. In some embodiments, the color calibration performed using the case 102 and/or the head-wearable device 108 is more accurate than existing solutions as the calibration images are captured in a known environment (e.g., the calibration images are captured within the case 102).

The disparity corrections systems and methods disclosed herein can be performed using low-cost imaging devices and provide a cost-effective solution compared to existing solutions (e.g., existing solutions that include a mini-waveguide solution and/or custom waveguide components).

In some embodiments, the case 102 includes on a top plane (opposite the bottom plane on which the imaging devices 104 are coupled) one or more additional markings or (subtle) calibration targets that are used to calibrate the imaging devices 104 if a calibration error between the imaging devices 104 occurs and/or if the imaging devices 104 fall out of calibration over time. More specifically, the one or more optical elements coupled to the case 102 and associated with the first lens assembly 110A and the second lens assembly 110B can capture one or more images of the calibration targets associated with the case 102 to calibrate the one or more optical elements. The calibration targets are at known positions and can be used to ensure that the imaging devices 104 are correctly aligned. As described above, the one or more calibration targets are associated with the case 102 and are positioned at a top plane of the storage device. Additionally, the calibration targets do not move relative to the case 102, such that if the imaging devices 104 are misaligned the can be compensated for by the difference in position between an aligned image and a misaligned image. In some embodiments, the imaging devices 104 calibration includes the estimation of the intrinsic and extrinsic parameters of the imaging devices 104 (e.g., a standard stereo camera calibration methodology).

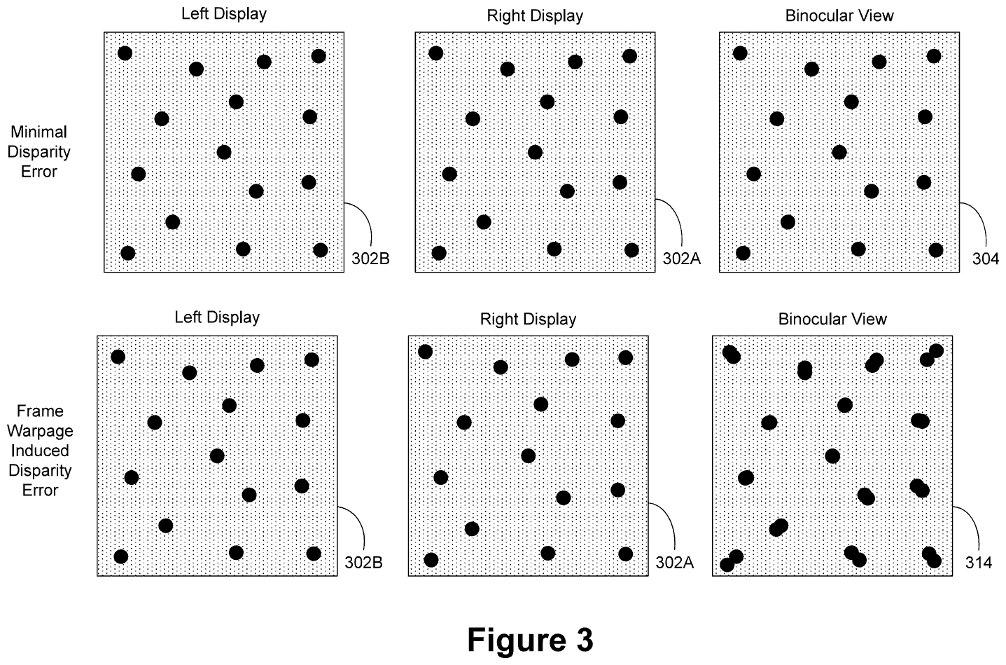

FIG. 3 illustrates a visual representation of a horizontal disparity error in artificial-reality glasses, in accordance with some embodiments. Specifically, FIG. 3 illustrates an example representation of an expected view and disparity error seen by a user. When a head-wearable device includes minimal disparity error, a first calibration pattern 302A viewed on a first display (e.g., a first lens assembly 110A; FIGS. 1A-2) and a second calibration pattern 302B viewed on a second display (e.g., a second lens assembly 110B; FIGS. 1A-2) are seen as overlapping when viewed by a user (e.g., as represented by first binocular view 304, which represents a user's point of view and shows the first and second calibration patterns 302A and 302B overlapping). Alternatively, when the head-wearable device includes a non-minimal disparity error (e.g., a disparity error induced by frame warpage), the first calibration pattern 302A viewed on the first display and the second calibration pattern 302B viewed on the second display are seen as offset when viewed by a user (e.g., as represented by second binocular view 314, which shows at least vertical and horizontal disparity (e.g., offsets) between the first and second calibration patterns 302A and 302B). Additionally or alternatively, in some embodiments, disparity can be measured in angles.

As described above in reference to FIG. 2, the case 102 and/or the head-wearable device 108 apply a disparity correction to one or both of the first lens assembly 110A and the second lens assembly 110B based on an amount of disparity in accordance with a determination that the amount of disparity between the respective calibration patterns satisfies calibration criteria. In some embodiments, the amount of disparity between the respective calibration patterns 302 is determined based on a pixel-level difference between a first calibration image 302A and a second calibration image 302B and the calibration criteria is satisfied when pixel-level difference is not substantially identical (e.g., the pixel-level difference is below a predetermined threshold (e.g., 2 mm, 1 mm. 0.2 mm, etc.). If the calibration criteria is satisfied based on a pixel-level difference, the case 102 and/or the head-wearable device 108 cause the head-wearable device 108 to apply a disparity correction reduce the pixel-level difference between the first calibration image 302A and the second calibration image 302B.

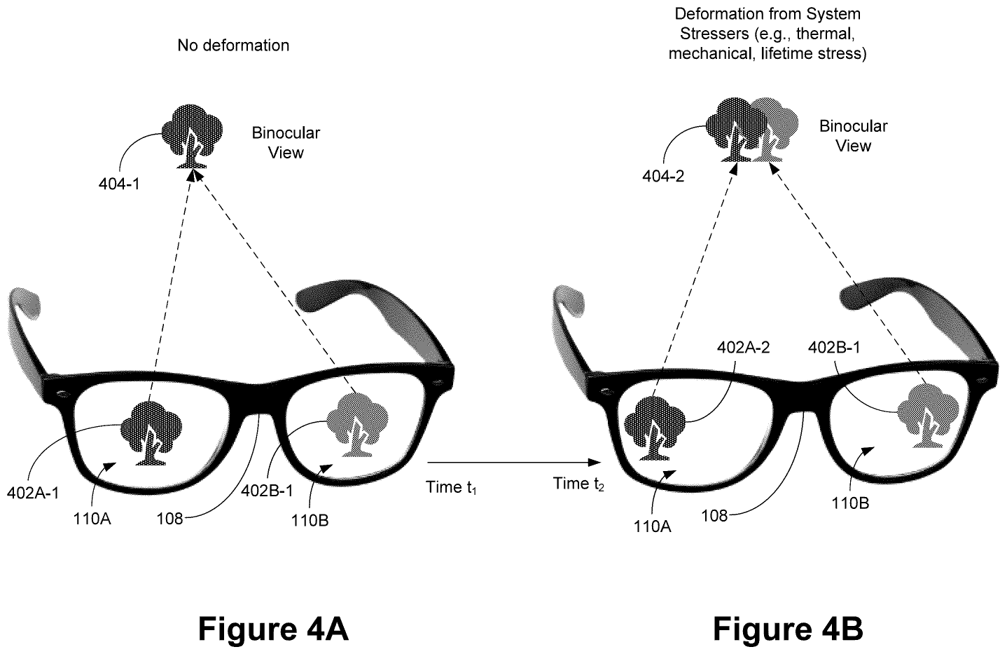

FIGS. 4A and 4B illustrate manifestation of a disparity error in artificial-reality glasses, in accordance with some embodiments. Specifically FIGS. 4A and 4B show a high-level flow of disparity created through system stresses (e.g., pixel errors as viewed by a user through use of a head-wearable device 108. For simplicity, the disparity shown in FIGS. 4A and 4B is horizontal pixel disparity; however, as described above, the head-wearable device 108 can include additional binocular disparity including, but not limited to, vertical disparity, convergent horizontal disparity, divergent horizontal disparity, and/or rotational disparity. As described above in reference to FIGS. 1A-3, a case 102 can work in conjunction with the head-wearable device 108 to correct disparity present at the head-wearable device 108.

In FIG. 4A, the head-wearable device 108 presents, at a first point in time (t1), a first image 402A-1 via a first lens assembly 110A and a second image 402B-1 via a second lens assembly 110B. At the first point in time (t1), there is substantially zero disparity such that a first binocular view 404-1 appears aligned (e.g., not distorted). In FIG. 4B, the head-wearable device 108 experiences one or more stresses that causes deformation of the head-wearable device 108 and/or otherwise experiences a change that result in disparity. For example, at a second point in time (t2), the head-wearable device 108, after experiencing a deformation, presents the first image 402A-2 via the first lens assembly 110A and the second image 402B-2 via the second lens assembly 110B, and the first image 402A-2 and the second image 402B-2 are misaligned resulting in a second binocular view 404-2 with a disparity error (e.g., a double image that would be perceivable to a user). As described above, binocular disparity error can be induced by thermal stress (changes in internal and/or external temperatures), mechanical stress (application of loads or other forces), and/or lifetime stresses (e.g., changes resulting from regular use). Additionally, any obstacles or changes in a display path (e.g., a waveguide or display projector assembly) can contribute to a disparity error.

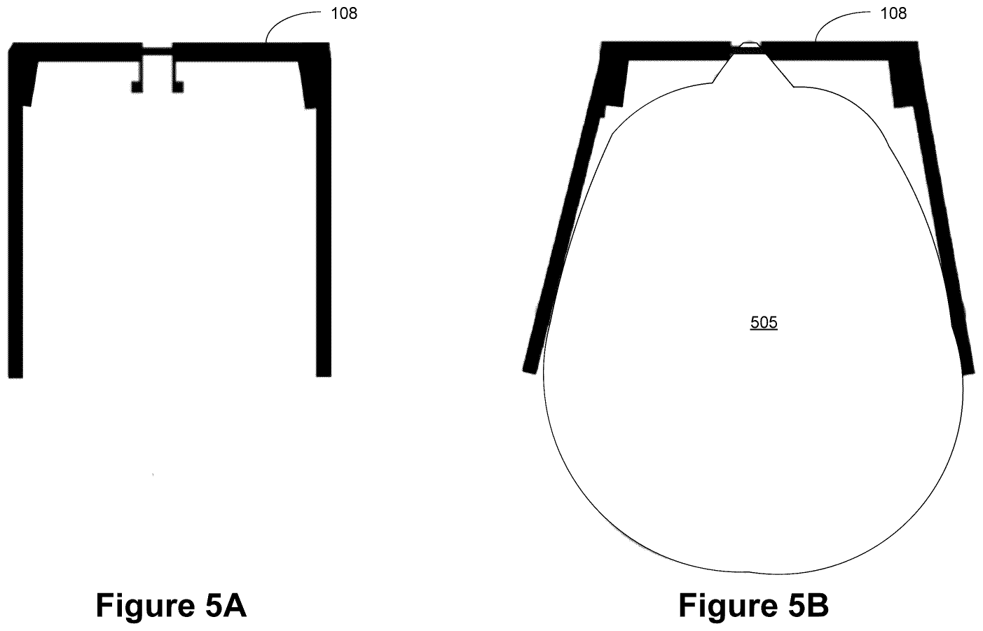

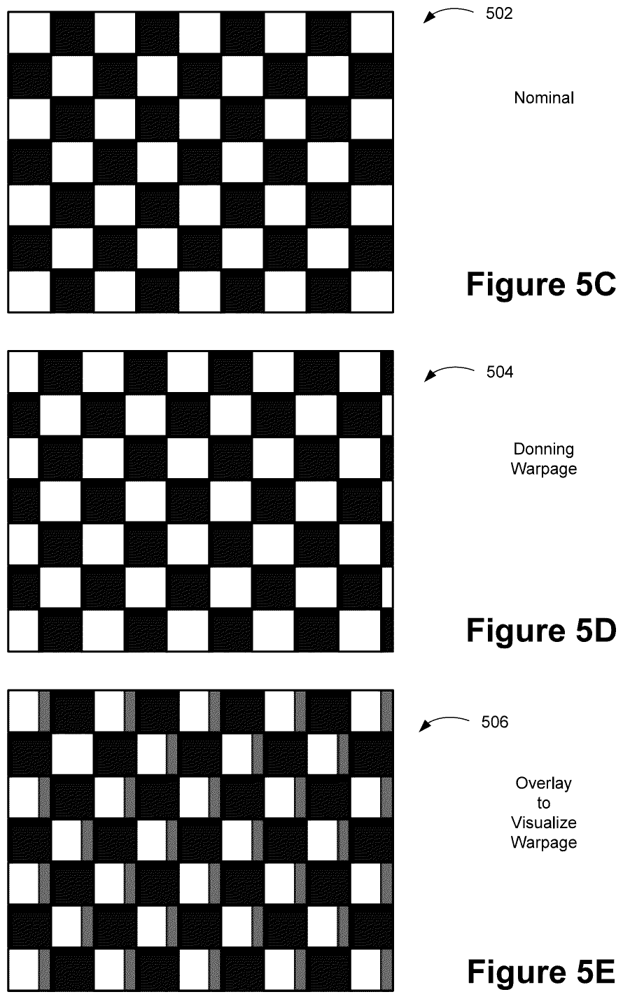

FIGS. 5A-5E illustrates an example stress applied to artificial-reality glasses and associated disparity error, in accordance with some embodiments. FIG. 5A shows a head-wearable device 108 before it is donned and FIG. 5B shows the head-wearable device 108 after it has been donned. As shown in FIG. 5B, when donned, the head-wearable device 108 is slightly deformed to fit a user 505. Deformation of the head-wearable device 108 can be based on a size of the user 505's head. For example, the head-wearable device 108 may not experience any deformation of the user 505's head is small. Alternatively, a large head size can result in larger deformations of the head-wearable device 108.

FIG. 5C shows an example of a first binocular view 502 visible via the head-wearable device 108 while in a nominal state. The nominal state is associated with the head-wearable device 108 in its undeformed condition as shown in FIG. 5A. Specifically, the first binocular view 502 represents the calibration pattern visible via the head-wearable device 108 shown in FIG. 5A.

FIG. 5D shows an example of a second binocular view 504 visible via the head-wearable device 108 while in an example deformed state. The example deformed state is associated with the head-wearable device 108 in its donned position as shown in FIG. 5B. Specifically, the second binocular view 504 represents the calibration pattern visible via the head-wearable device 108 shown in FIG. 5B (e.g., experiencing some warpage due to the user 505 donning the head-wearable device 108.

FIG. 5E shows the first binocular view 502 and the second binocular view 504 overlaid. The binocular view overlay 506 allows for the visualization of the disparity caused by the warpage. For example, as shown in FIG. 5E, the second binocular view 504 includes horizontal disparity when compared with the first binocular view 502.

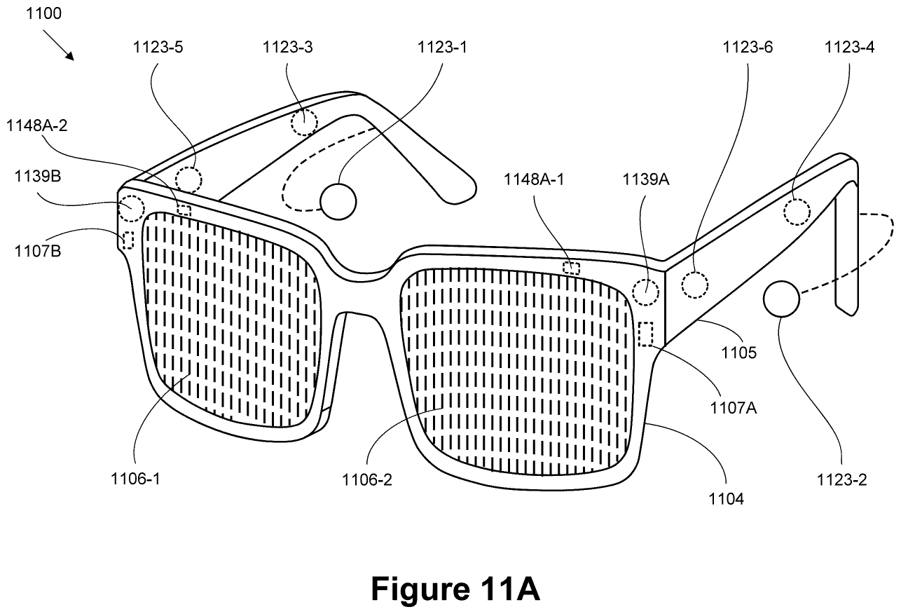

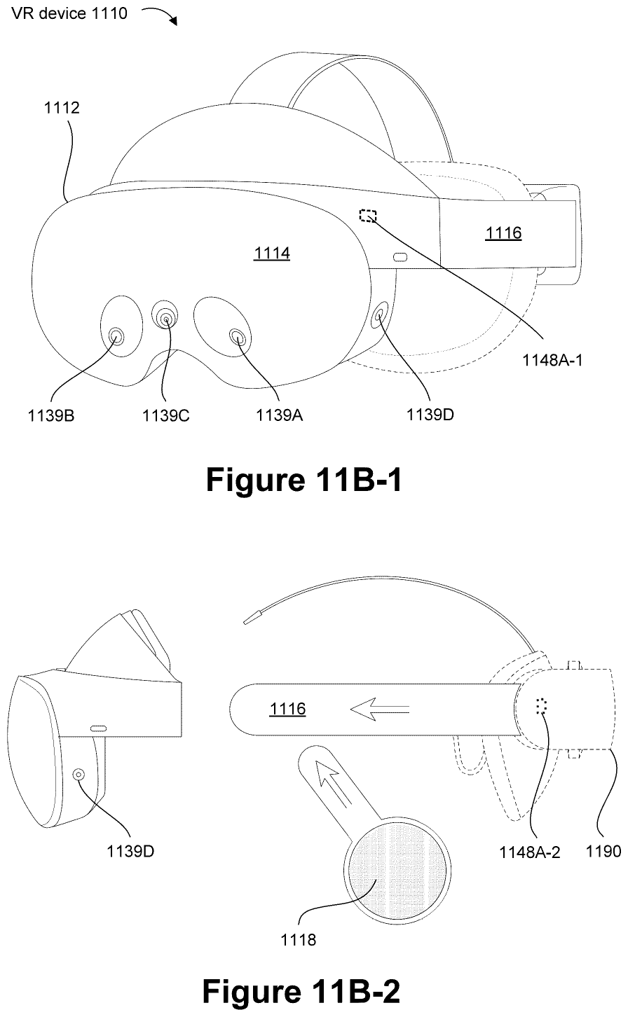

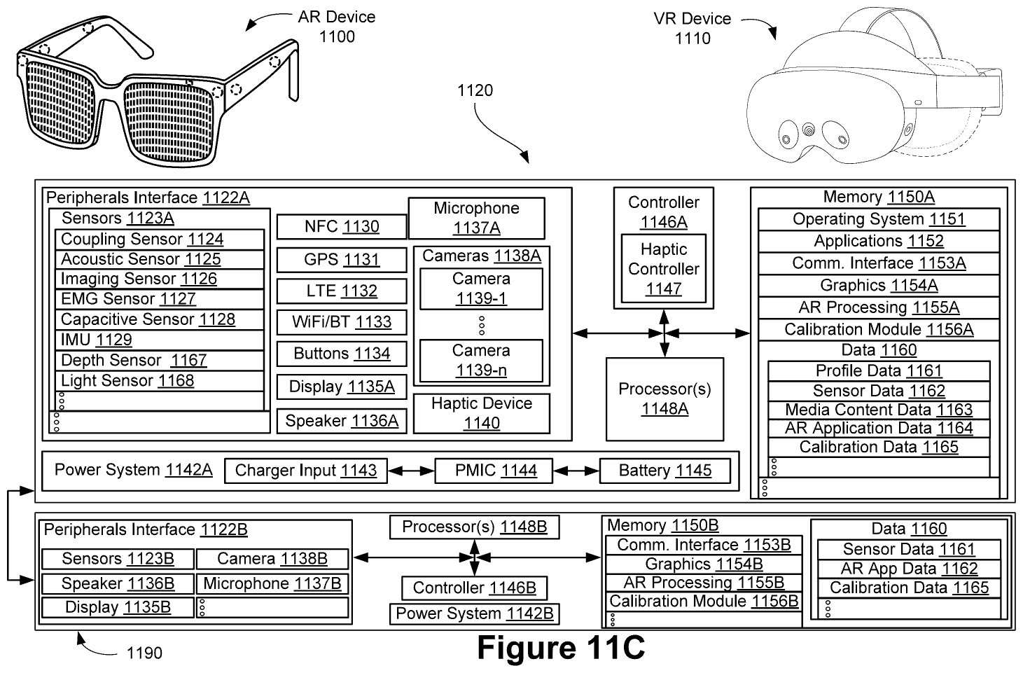

In some embodiments, the head-wearable device 108 and/or the case 102 are configured to perform online disparity. In some embodiments, in accordance with a determination that the head-wearable device 108 is donned, the head-wearable device 108 and/or the case 102 capture deformation data regarding deformation of a frame of the head-wearable device and, based on a determination that the deformation data indicates that an amount of disparity while the head-wearable device 108 is donned satisfies the calibration criteria, apply, based on the amount of disparity, a disparity correction to one or both of the first lens assembly 110A and/or a second lens assembly 110B. The deformation data includes at least deformation data before the head-wearable device 108 is donned and deformation data while the head-wearable device 108 is donned. In some embodiments, the disparity correction is based on a difference between the deformation data before the head-wearable device 108 is donned and the deformation data while the head-wearable device 108 is donned such that the difference is reduced. In some embodiments, the deformation data regarding the deformation of the frame of the head-wearable device 108 includes one or more images captured by the one or more imaging devices (e.g., image sensors 1126; FIGS. 11A-11C) coupled to the frame of the head-wearable device 108, and the amount of disparity is based on a difference (e.g., pixel level differences) between at least a first image captured by the one or more imaging devices before the head-wearable device 108 is donned and at least a second image captured by the one or more imaging devices while the head-wearable device 108 is donned.

Alternatively, or in addition, in some embodiments the data regarding the deformation of the frame of the head-wearable device 108 is captured by one or more force sensors coupled to the frame of the head-wearable device 108, and the amount of disparity is based on a change in measurements from the one or more force sensors before the head-wearable device 108 is donned and while the head-wearable device 108 is donned. The one or more force sensors are configured to detect deformation of the frame of the head-wearable device 108. In some embodiments, the one or more force sensors are strain gauge sensors.

As described above, the case 102 and/or the head-wearable device 108 are configured to use one or more sensors (e.g., sensors 1123; FIGS. 11A-11C) coupled with the head-wearable device 108 to actively detect and correct disparity. Specifically, the one or more sensors coupled with the head-wearable device 108 can be used to actively correct disparity while the head-wearable device 108 is in-use (e.g., actively presenting data). This allows for the case 102 and/or the head-wearable device 108 to correct for disparity errors experienced by the head-wearable device 108 while being used.

In some embodiments, online disparity correction (e.g., disparity correction performed while the head-wearable device 108 is in-use and/or donned) is used to correct disparity errors caused by mechanical torsion (which commonly occurs when the user 505 dons and/or doffs the head-wearable device 108). For example, when the dons the head-wearable device 108, the head-wearable device 108 can warp due to a mismatch between the head-wearable device 108 frame and user 505's head size. In some embodiments, the head-wearable device 108 uses distinct sensor types for active disparity correction and correlation of data across the distinct sensor types to detect and correct for pixel disparity. In some embodiments, the distinct sensor types include strain gauges (e.g., across the user 505's nose bridge), inertial measurement units (e.g., coupled at distinct portions of the head-wearable device 108 and configured to detect the head-wearable device 108 being picked up and/or turn on the camera for video and/or calibration capture), and point-of-view imaging devices of the head-wearable device 108 (e.g., to turn on in a low-power and lower resolution video mode to capture a calibration video as the user is donning the head-wearable device 108 to capture a pixel shift as a stress at the head-wearable device 108 occurs).

For example, in some embodiment, the point-of-view imaging devices (once activated) are able to visualize the frame distortion while looking at a calibration target. Specifically, the point-of-view imaging devices of a head-wearable device 108 can begin to capture video and image the distortion due to frame warpage as it occurs. The distortion due to frame warpage can be correlated back to the error in pixel disparity that will arise between the displays. The data from one or more inertial measurement units can be used to synchronize the capture of video data (e.g., start capturing video as the user starts donning the head-wearable device 10-8 on their head). Similarly, the data from the one or more strain gauges across the nose bridge can be used to synchronize the capture of video data (e.g., when the user places the head-wearable device 108 on their head). In some embodiments, data from one or both of the strain gauges and/or the inertial measurement units can be used to synchronize the captured vide data.

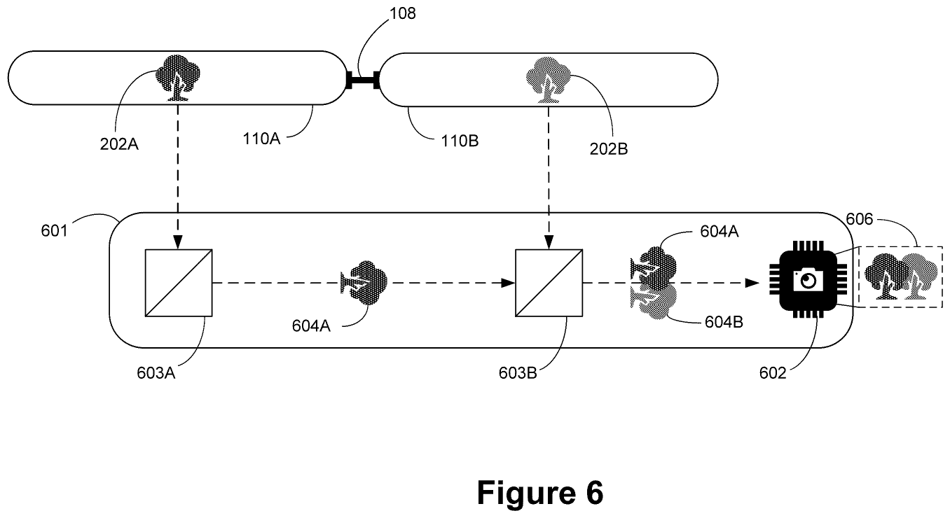

FIG. 6 illustrates another case for calibrating artificial-reality glasses, in accordance with some embodiments. The other case 601 includes an imaging device 602 (analogous to imaging device 104; FIGS. 1A-3) and at least two optical elements 603. The at least two optical elements 603 can be passive optical elements and are configured to enable the use of one optical path to capture one or more calibration images of the presented calibration pattern 202. The at least two optical elements 603 can be used to reduce the reduce the number of imaging devices 602 in the case (e.g., from at least two imaging devices to one imaging device). The at least two optical elements 603 need to be aligned to enable the accurate detection of disparity.

In some embodiments, a first optical element 603A of the one or more optical elements is configured to redirect the one or more first calibration patterns 202A displayed using the first lens assembly 110A towards an imaging device 602, and a second optical element 603B of the one or more optical elements is configured to redirect the one or more second calibration patterns 202B displayed using the second lens assembly 110B towards the imaging device 602. The imaging device 602 is configured to capture the one or more calibration patterns 202 displayed using the first lens assembly 110A and the second lens assembly 110B that is redirected by the first optical 603A and the second optical element 603B, respectively.

For example, as shown in FIG. 6, the first lens assembly 110A and the second lens assembly 110B of a head-wearable device 108 present a first calibration pattern 202A and a second calibration pattern 202B, respectively. The at least two optical elements 603 detect the calibration patterns 202 and provide a first representation of the calibration pattern 604A and a second representation of the calibration pattern 604B to the to the imaging device 602. The first representation of the calibration pattern 604A and the second representation of the calibration pattern 604B are provided to the imaging device 602 using a single optical path (represented by the dotted lines between the at least two optical elements 603 and the imaging device 602). For example, as shown in FIG. 6, both the first and second representations of the calibration patterns 604A and 604B are combined when provided to the imaging device 602. The imaging device 602 is configured to capture one or more calibration images 606 that are used to determine the presence of disparity and correct detected disparity error, as discussed above in reference to FIGS. 1A-5D.

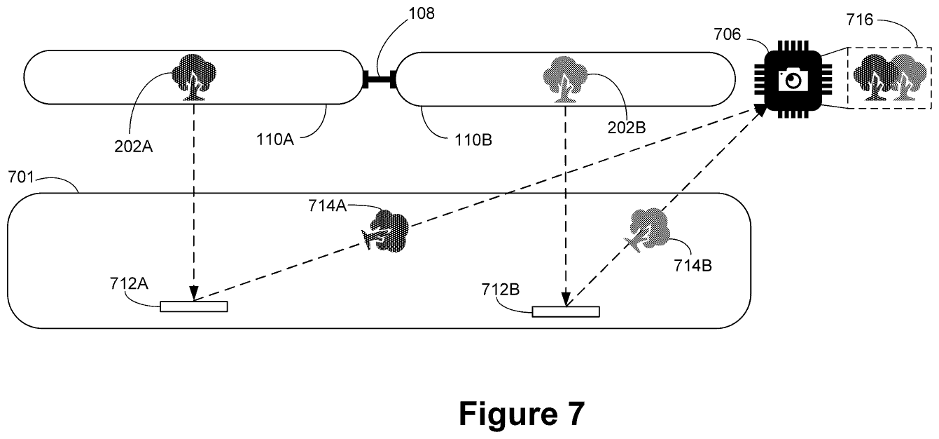

FIG. 7 illustrates yet another case for calibrating artificial-reality glasses, in accordance with some embodiments. The yet other case 701 includes at least two optical elements 712. The at least two optical elements 712 can be passive optical elements and are configured to enable the use of one optical path to capture one or more calibration images of the presented calibration pattern 202. The at least two optical elements 712 can be used to reduce the reduce the number of imaging devices in the case 701 (e.g., from at least two imaging devices to no imaging device). Specifically, the at least two optical elements 712 redirect the calibration patterns 202 to one or more imaging devices 706 (e.g., image sensors 1126; FIGS. 11A-11C) of a head-wearable device 108, which capture one or more calibration images 716 for detecting and corrected disparity. The at least two optical elements 712 need to be aligned to enable the accurate detection of disparity.

In some embodiments, a first optical element 712A of the one or more optical elements is configured to redirect the one or more first calibration patterns 202A displayed using the first lens assembly 110A towards the one or more imaging devices 706 of the head-wearable device 108, and a second optical element 712B of the one or more optical elements is configured to redirect the one or more second calibration patterns 202B displayed using the second lens assembly 110B towards the one or more imaging devices 706 of the head-wearable device 108. The imaging device 706 is configured to capture the one or more calibration patterns 202 displayed using the first lens assembly 110A and the second lens assembly 110B that is redirected by the first optical 712A and the second optical element 712B, respectively.

For example, as shown in FIG. 7, the first lens assembly 110A and the second lens assembly 110B of the head-wearable device 108 present the first calibration pattern 202A and the second calibration pattern 202B, respectively. The at least two optical elements 712 detect the calibration patterns 202 and provide a first representation of the calibration pattern 714A and a second representation of the calibration pattern 714B to the to the imaging device 706. The first representation of the calibration pattern 714A and the second representation of the calibration pattern 714B are provided to the imaging device 706 using a single optical path (represented by the dotted lines between the at least two optical elements 712 and the imaging device 706). For example, as shown in FIG. 7, both the first and second representations of the calibration patterns 714A and 714B are provided directly to the imaging device 706. The imaging device 706 is configured to capture one or more calibration images 716 that are used to determine the presence of disparity and correct detected disparity error, as discussed above in reference to FIGS. 1A-5D.

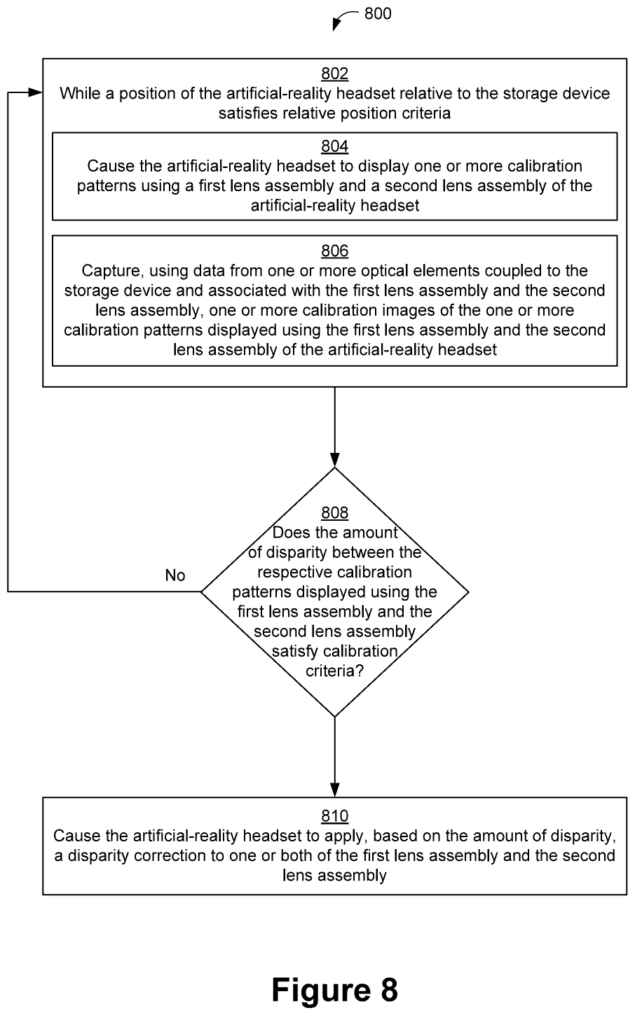

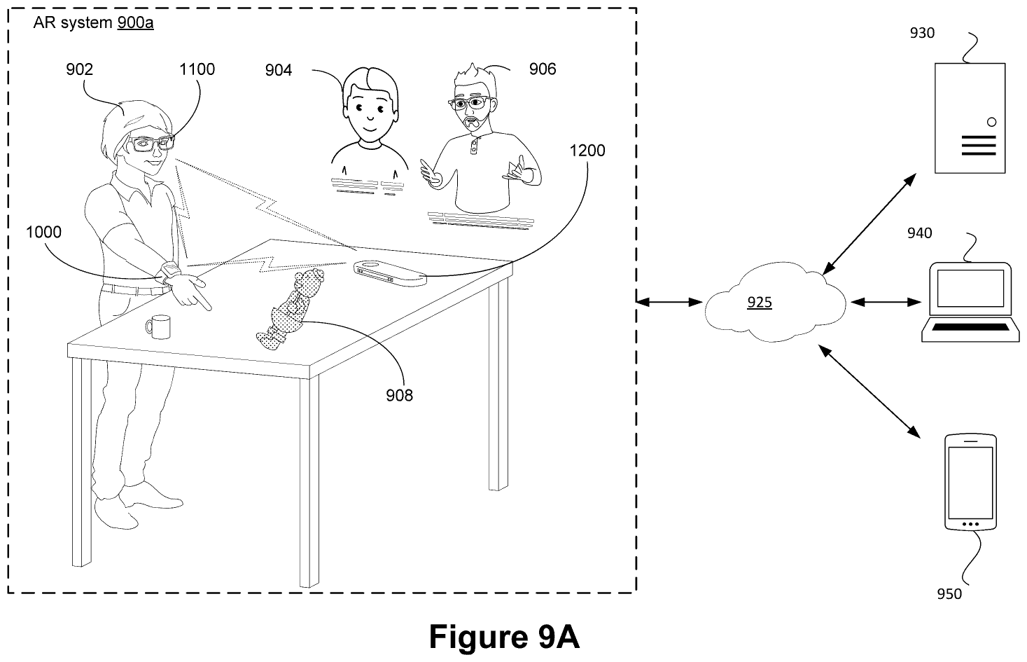

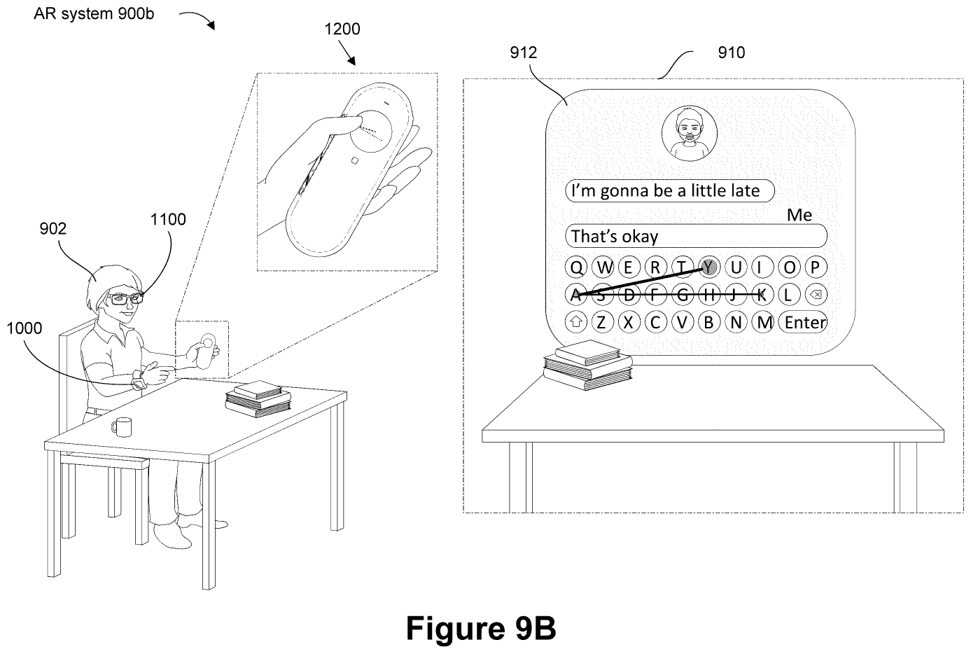

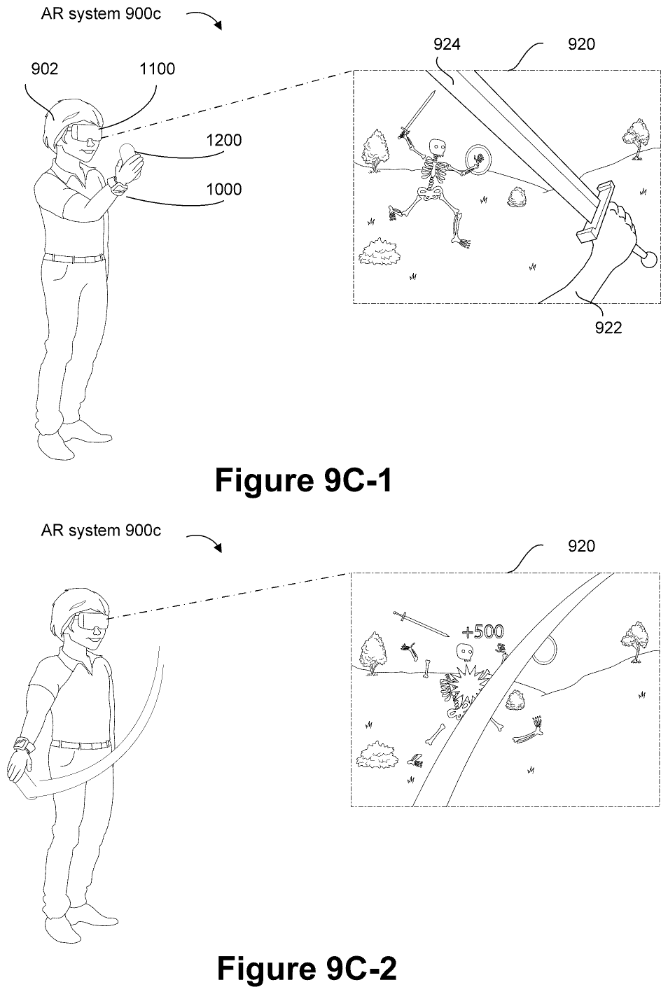

FIG. 8 illustrates a flow diagram of a method of disparity correction, in accordance with some embodiments. Operations (e.g., steps) of the method 800 can be performed by one or more processors (e.g., central processing unit and/or MCU) of a system (e.g., a case 102 and/or a head-wearable device 108; FIGS. 1A-7). At least some of the operations shown in FIG. 8 correspond to instructions stored in a computer memory or computer-readable storage medium (e.g., storage, RAM, and/or memory, such as memory 1150 (FIG. 11C)). Operations of the method 800 can be performed by a single device alone or in conjunction with one or more processors and/or hardware components of another communicatively coupled device (e.g., a wrist-wearable device 1000, a handheld intermediary processing device 1200, a server 930, a computer 940, a mobile devices 950, and/or other devices described below in reference to FIG. 9A and FIGS. 9B) and/or instructions stored in memory or computer-readable medium of the other device communicatively coupled to the system. In some embodiments, the various operations of the methods described herein are interchangeable and/or optional, and respective operations of the methods are performed by any of the aforementioned devices, systems, or combination of devices and/or systems. For convenience, the method operations will be described below as being performed by particular component or device, but should not be construed as limiting the performance of the operation to the particular device in all embodiments.

(A1) FIG. 8 shows a flow chart of a method 800 of calibrating display of visual data presented via an artificial-reality headset, in accordance with some embodiments. The method 800 occurs at a storage device (e.g., any case described above in reference to FIGS. 1A-7) communicatively coupled with an artificial-reality headset (e.g., any head-wearable device described above in reference to FIGS. 1A-7). The storage device is communicatively coupled with an imaging device (e.g., an imaging device coupled with the storage device and/or imaging device that is part of the head-wearable device.

In some embodiments, the method 800 includes, while (802) a position of the artificial-reality headset relative to the storage device satisfies relative position criteria, causing (804) the artificial-reality headset to display one or more calibration patterns using a first lens assembly and a second lens assembly of the artificial-reality headset, and capturing (806), using the one or more imaging devices coupled to the storage device and associated with the first lens assembly and the second lens assembly, one or more calibration images of the one or more calibration patterns displayed using the first lens assembly and the second lens assembly of the artificial-reality headset. The method 800 includes, in accordance with a determination, based on the one or more calibration images, that an amount of disparity between the respective calibration patterns displayed using the first lens assembly and the second lens assembly satisfies (808) calibration criteria (“Yes” at operation 808) causing (810) the artificial-reality headset to apply, based on the amount of disparity, a disparity correction to one or both of the first lens assembly and the second lens assembly. For example, as described above in reference to FIGS. 1A-7, calibration patterns presented by a first lens assembly 110A and a second lens assembly 110B can be captured via an imaging device communicatively coupled with the case 102 such that captured images of the calibration patterns can be used to correct disparity errors present at the head-wearable device 108.

Alternatively, the method 800 includes, in accordance with a determination, based on the one or more calibration images, that the amount of disparity between the respective calibration patterns displayed using the first lens assembly and the second lens assembly does not satisfy the calibration criteria (“No” at operation 808) returning to operation 802.

In some embodiments, disparity is measured in angles (e.g., degrees, arcmin, etc.), distance (e.g., millimeters), and/or pixels. In some embodiments, the disparity includes vertical disparity, convergent vertical disparity, and/or divergent horizontal disparity. The different types of disparity are described above. In some embodiments, disparity is caused by stresses experienced at the artificial-reality headset, such as thermal stresses, mechanical stresses, lifetime stresses, and/or other types of stresses.

(A2) In some embodiments of A1, the amount of disparity is determined based on a pixel-level difference between a first calibration image of the one or more calibration images and a second calibration image of the one or more calibration images, wherein the first calibration image is associated with the first lens assembly and the second calibration is associated with the second lens assembly. The method 800 further includes determining based on the pixel-level difference between the first calibration image and the second calibration image, the disparity correction. The disparity correction reduces the pixel-level difference between the first calibration image and the second calibration image. For example, the same pixel between two respective calibration images (associated with respective lens assemblies) can be compared to measure the disparity between the displayed data. Different examples of the distinct disparity measurements are provided above in reference to FIGS. 1A-5E.

(A3) In some embodiments of any one of A1-A2, the causing the artificial-reality headset to apply, based on the amount of disparity, the disparity correction to one or both of the first lens assembly and the second lens assembly includes causing the artificial-reality headset to apply the disparity correction to one or more images prior to displaying the one or more images using the first lens assembly and the second lens assembly. In other words, the artificial-reality headset corrects for disparity before data is presented to a user.

(A4) In some embodiments of any one of A1-A3, the artificial-reality headset displays the one or more calibration patterns using a first projector assembly associated with the first lens assembly and a second project assembly associated with the second lens assembly. Additionally, the causing the artificial-reality headset to apply, based on the amount of disparity, the disparity correction to one or both of the first lens assembly and the second lens assembly includes causing the artificial-reality headset to modify a first image projection from the first projector assembly associated with the first lens assembly and/or a second image projection from the second project assembly associated with the second lens assembly to reduce the amount of disparity.

(A5) In some embodiments of any one of A1-A4, the amount of disparity is a first amount of disparity, the disparity correction is a first disparity correction, and the method 800 further includes, in accordance with a determination that the artificial-reality headset is being donned, causing the artificial-reality headset to capture deformation data regarding deformation of a frame of the artificial-reality headset and, in accordance with a determination, based on the deformation data, that a second amount of disparity while the artificial-reality headset is donned satisfies the calibration criteria, causing the artificial-reality headset to apply, based on the second amount of disparity, a second disparity correction to one or both of the first lens assembly and the second lens assembly. The deformation data includes at least deformation data before the artificial-reality headset is donned and deformation data while the artificial-reality headset is donned. In other words, the method 800 can be used for online disparity correction (along with offline disparity correction). Examples of online disparity correction are provided above in reference to FIGS. 5A-5E.

(A6) In some embodiments of A5, the second disparity correction is based on a difference between the deformation data before the artificial-reality headset is donned and the deformation data while the artificial-reality headset is donned such that the difference is reduced. Examples of online disparity correction are provided above in reference to FIGS. 5A-5E.

(A7) In some embodiments of any one of A5-A6, the deformation data regarding the deformation of the frame of the artificial-reality headset includes one or more images captured by the one or more imaging devices coupled to the frame of the artificial-reality headset, and the second amount of disparity is based on a difference (e.g., pixel) between at least a first image of the one or more images before the artificial-reality headset is donned and at least a second image of the one or more images while the artificial-reality headset is donned. Examples of online disparity correction are provided above in reference to FIGS. 5A-5E.

(A8) In some embodiments of any one of A5-A7, the data regarding the deformation of the frame of the artificial-reality headset is captured by one or more force sensors (e.g., strain gauges) coupled to the frame of the artificial-reality headset and the amount of disparity is based on a change in measurements from the one or more force sensors before the artificial-reality headset is donned and while the artificial-reality headset is donned. The one or more force sensors are configured to detect deformation of the frame of the artificial-reality headset. Different types of sensors can be used, such as strain gauges, inertial measurement units, and/or point-of-view image sensors. Different examples of the sensors are provided above in reference to FIGS. 5A-5E.

(A9) In some embodiments of any one of A1-A8, the relative position criteria include a first relative position criteria that includes the artificial-reality headset being a substantially zero distance from the storage device. In other words, the artificial-reality headset being stored within the storage device and/or on top of the storage device. In some embodiments, the relative position criteria include the artificial-reality headset mechanically and electrically coupled to the charging contacts of the storage device. In some embodiments, the relative position criteria include the storage being completely closed with the artificial-reality headset inside the storage device. In some embodiments, the storage device includes a mold or mount to guide the artificial-reality headset into a correct location or position. Specifically, the storage device is configured to position the artificial-reality headset in a predetermined location and/or position to allow for offline disparity error correction. Examples of offline disparity error correction are provided above in reference to FIGS. 1A-4B.

(A10) In some embodiments of any one of A1-A9, the relative position criteria include a second relative position criteria that includes the artificial-reality headset being a substantially non-zero distance from the storage device. In other words, the disparity error correction can be performed when the artificial-reality headset is not within the storage device. In some embodiments, when the artificial-reality headset is a substantially non-zero distance from the storage device, online disparity error correction is performed. Online disparity error correction is described above in reference to FIGS. 5A-5E. In some embodiments, the artificial-reality headset is suspended above a disparity correction portion (e.g., the one or more imaging devices) of the storage device such that the artificial-reality headset is at a non-zero distance from the storage device. For example, the storage device includes a support mechanism that holds the side (e.g., temple arms) of artificial-reality glasses so that the artificial-reality glasses are suspended above the storage device.

(A11) In some embodiments of any one of A1-A10, a first imaging device of the one or more imaging devices is configured to capture the one or more calibration patterns displayed using the first lens assembly and a second imaging device of the one or more imaging devices is configured to capture the one or more calibration patterns displayed using the second lens assembly. The first imaging device is positioned at a first region associated with the first lens assembly, and the second imaging device is positioned at a second region associated with the second lens assembly. As described above in reference to FIGS. 1A-1B, the imaging devices can be aligned with an eyebox of the artificial-reality headset.

(A12) In some embodiments of A11, the first region and the second region are a predefined distance apart. In some embodiments, predefined distance includes a distance within an interpupillary distance range associated with the artificial-reality headset. Additionally, in some embodiments, the first region and the second region are located proximate to a focal point associated with the first lens assembly and the second lens assembly, respectively. Examples of the predefined distance (e.g., baseline distance 103) are provided above in reference to FIGS. 1A-2.

(A13) In some embodiments of any one of A11-A12, the first imaging device and the second imaging device are further positioned at a backplane associated with the storage device. For example, as described above in reference to FIGS. 1A-2, the one or more imaging devices can be positioned at a backplane of a storage device such that they operate as virtual eyes that look into the artificial-reality headset (e.g., the respective lens assemblies). Examples of the different positions of the imaging devices are provided above in reference to FIGS. 1A-2.

(A14) In some embodiments of any one of A11-A13, the first imaging device is a first camera, and the second imaging device is a second camera. As described above in reference to FIGS. 1A-1B, the cameras can be red-blue-green cameras, ultra-wide-angle cameras, wide-angle cameras, fish-eye cameras, spherical cameras, telephoto cameras, a depth-sensing cameras, or other types of cameras.

(A15) In some embodiments of any one of A1-A14, the storage device include one or more optical elements including a first optical element and a second optical element. The first optical element is configured to redirect the one or more calibration patterns displayed using the first lens assembly towards an imaging device (of the one or more imaging devices) and the second optical element is configured to redirect the one or more calibration patterns displayed using the second lens assembly towards the imaging device. The imaging device is configured to capture the one or more calibration patterns displayed using the first lens assembly and the second lens assembly that is redirected by the first optical and the second optical element, respectively. Examples of the different optical elements are provided above in reference to FIGS. 6-7.

(A16) In some embodiments of any one of A1-A15, the method 800 further includes capturing, using the one or more imaging devices coupled to the storage device and associated with the first lens assembly and the second lens assembly, one or more calibration targets associated with the storage device, and calibrating the one or more imaging devices based on the one or more calibration targets. The calibration targets are at known positions within the storage device and can be used to calibrate the imaging devices. The calibration targets are described above in reference to FIGS. 1A-1B.

(A17) In some embodiments of A16, the one or more calibration targets associated with the storage device are positioned (or disposed) at a top plane of the storage device. The calibration target should not move relative to the case, such that if the cameras are misaligned it can be compensated by the difference in position between an aligned image and a misaligned image. The calibration targets are described above in reference to FIGS. 1A-1B.

(A18) In some embodiments of any one of A1-A17, the method 800 further includes, in accordance with a determination, based on the one or more calibration images, that an amount of color disparity between the one or more calibration images and the respective calibration patterns satisfies color calibration criteria, causing the artificial-reality headset to apply, based on the amount of color disparity, a color disparity correction to one or both of the first lens assembly and the second lens assembly. In other words, the image data is captured in color and the color images can be used to correct color disparity. In some embodiments, the image data is used to perform color calibration of the display. In some embodiments, the method 800 allows for accurate color calibration as the color images can be captured in a known environment (e.g., within the storage device). Color correction is discussed above in reference to FIG. 2.

(B1) In accordance with some embodiments, a system that includes one or more of a wrist wearable device, a head-wearable device, a storage device, and/or a handheld intermediary processing device, and the system is configured to perform operations corresponding to any of A1-A18.

(C1) In accordance with some embodiments, a non-transitory computer readable storage medium including instructions that, when executed by a computing device in communication with a wrist wearable device, a storage device, a head-wearable device, and/or a handheld intermediary processing device, cause the computer device to perform operations corresponding to any of A1-A18.

(D1) In accordance with some embodiments, a means on a wrist-wearable device, a head-wearable device, a storage device, and/or a handheld intermediary processing device for performing or causing performance of the method of any of A1-A18.

(E1) In accordance with some embodiments, a storage device communicatively coupled with a head-wearable device, the storage device configured to perform the operations of any of A1-A18.

(F1) In accordance with some embodiments, a head-wearable device communicatively coupled with a storage device, the head-wearable device configured to perform the operations of any of A1-A18.

The devices described above are further detailed below, including systems, wrist-wearable devices, headset devices, and smart textile-based garments. Specific operations described above may occur as a result of specific hardware, such hardware is described in further detail below. The devices described below are not limiting and features on these devices can be removed or additional features can be added to these devices. The different devices can include one or more analogous hardware components. For brevity, analogous devices and components are described below. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device 1000, a head-wearable device, an HIPD 1200, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., virtual-reality animations, such as three-dimensional modeling); (iv) a field-programmable gate array (FPGA) that can be programmed and reconfigured after manufacturing and/or customized to perform specific tasks, such as signal processing, cryptography, and machine learning; (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or DSPs. As described herein, a graphics module is a component or software module that is designed to handle graphical operations and/or processes, and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include: (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) POGO pins, which may be small, spring-loaded pins configured to provide a charging interface; (v) wireless charging interfaces; (vi) global-position system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device); (ii) biopotential-signal sensors; (iii) inertial measurement unit (e.g., IMUs) for detecting, for example, angular rate, force, magnetic field, and/or changes in acceleration; (iv) heart rate sensors for measuring a user's heart rate; (v) SpO2 sensors for measuring blood oxygen saturation and/or other biometric data of a user; (vi) capacitive sensors for detecting changes in potential at a portion of a user's body (e.g., a sensor-skin interface) and/or the proximity of other devices or objects; and (vii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include: (i) electroencephalography (EEG) sensors configured to measure electrical activity in the brain to diagnose neurological disorders; (ii) electrocardiogramar EKG) sensors configured to measure electrical activity of the heart to diagnose heart problems; (iii) electromyography (EMG) sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications, (x) camera applications, (xi) web-based applications; (xii) health applications; (xiii) artificial-reality (AR) applications, and/or any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). In some embodiments, a communication interface can refer to a software layer that enables different software programs to communicate with each other (e.g., application programming interfaces (APIs) and protocols such as HTTP and TCP/IP).

As described herein, a graphics module is a component or software module that is designed to handle graphical operations and/or processes, and can include a hardware module and/or a software module.

As described herein, non-transitory computer-readable storage media are physical devices or storage medium that can be used to store electronic data in a non-transitory form (e.g., such that the data is stored permanently until it is intentionally deleted or modified).

### Example AR Systems

FIGS. 9A-9C-2 illustrate example artificial-reality systems, in accordance with some embodiments. FIG. 9A shows a first AR system 900a and first example user interactions using a wrist-wearable device 1000, a head-wearable device (e.g., AR device 1100), and/or a handheld intermediary processing device (HIPD) 1200. FIG. 9B shows a second AR system 900b and second example user interactions using a wrist-wearable device 1000, AR device 1100, and/or an HIPD 1200. FIGS. 9C-1 and 9C-2 show a third AR system 900c and third example user interactions using a wrist-wearable device 1000, a head-wearable device (e.g., virtual-reality (VR) device 1110), and/or an HIPD 1200. As the skilled artisan will appreciate upon reading the descriptions provided herein, the above-example AR systems (described in detail below) can perform various functions and/or operations described above with reference to FIGS. 1A-8.

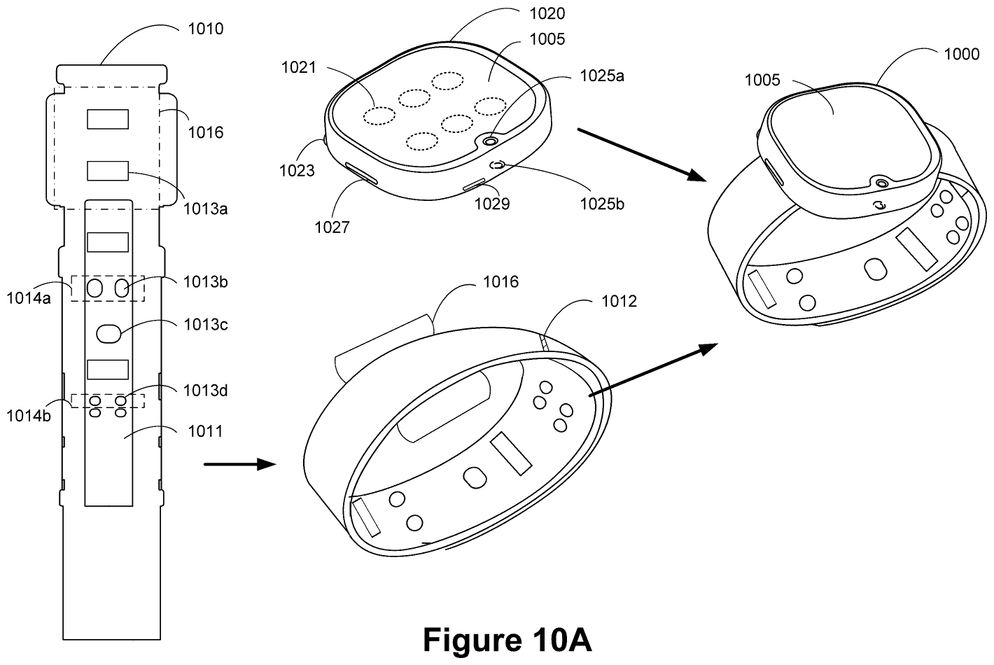

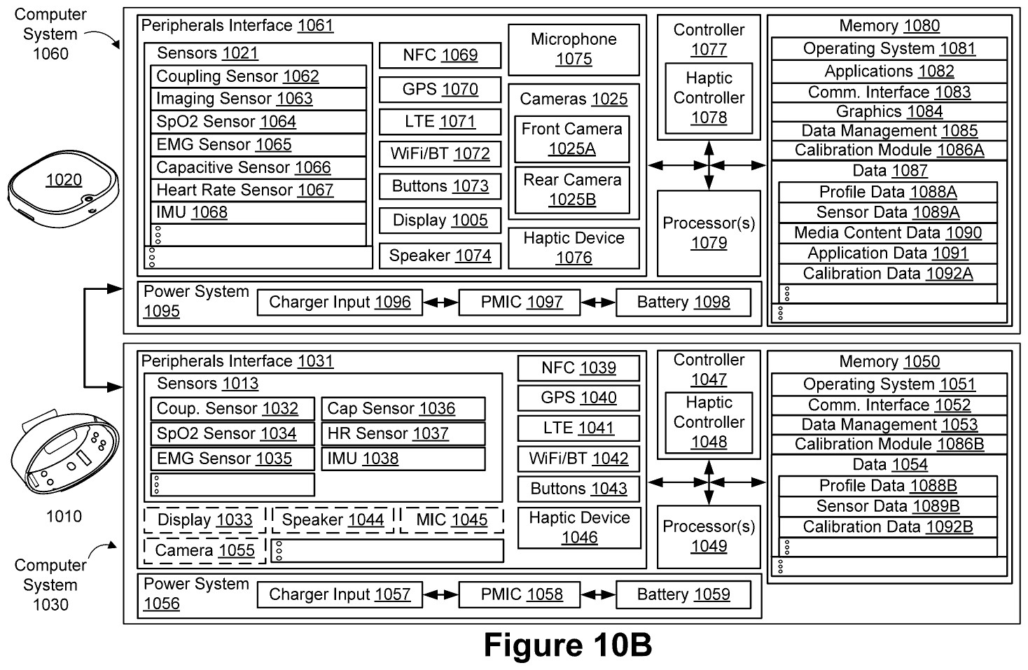

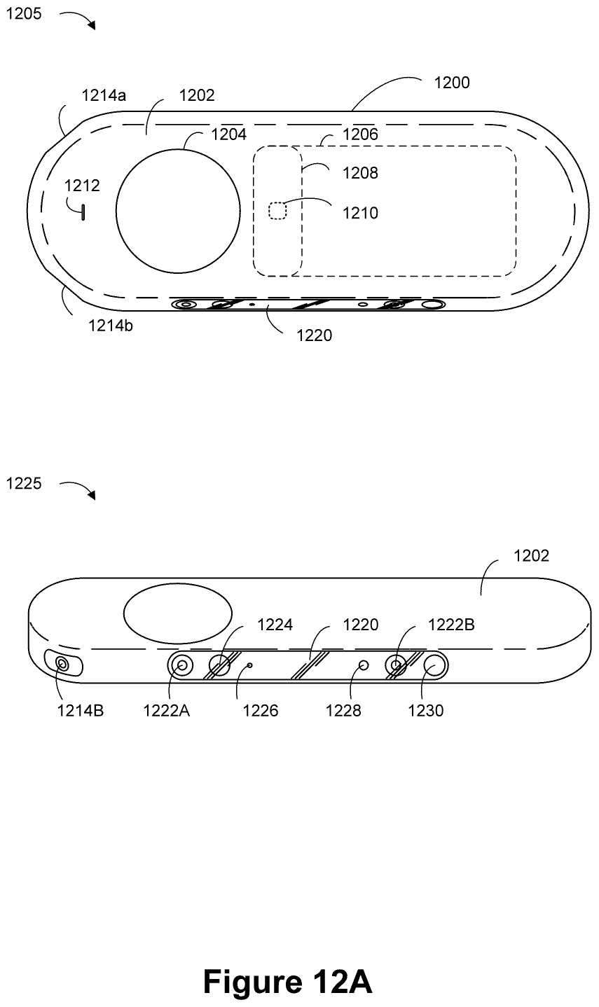

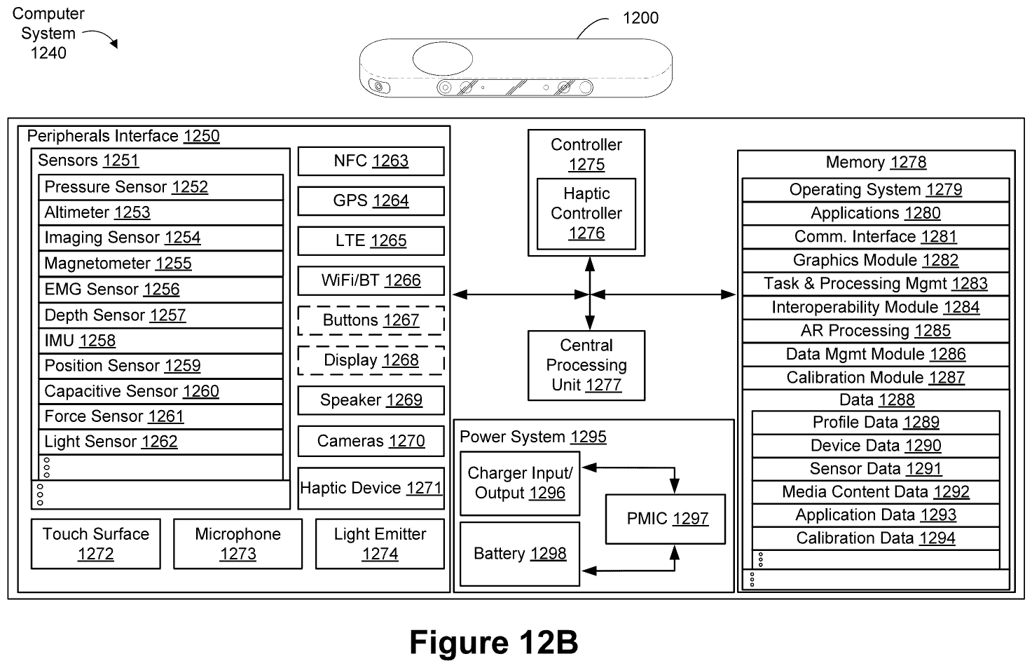

The wrist-wearable device 1000 and its constituent components are described below in reference to FIGS. 10A-10B, the head-wearable devices and their constituent components are described below in reference to FIGS. 11A-11D, and the HIPD 1200 and its constituent components are described below in reference to FIGS. 12A-12B. The wrist-wearable device 1000, the head-wearable devices, and/or the HIPD 1200 can communicatively couple via a network 925 (e.g., cellular, near field, Wi-Fi, personal area network, wireless LAN, etc.). Additionally, the wrist-wearable device 1000, the head-wearable devices, and/or the HIPD 1200 can also communicatively couple with one or more servers 930, computers 940 (e.g., laptops, computers, etc.), mobile devices 950 (e.g., smartphones, tablets, etc.), and/or other electronic devices via the network 925 (e.g., cellular, near field, Wi-Fi, personal area network, wireless LAN, etc.)

Turning to FIG. 9A, a user 902 is shown wearing the wrist-wearable device 1000 and the AR device 1100, and having the HIPD 1200 on their desk. The wrist-wearable device 1000, the AR device 1100, and the HIPD 1200 facilitate user interaction with an AR environment. In particular, as shown by the first AR system 900a, the wrist-wearable device 1000, the AR device 1100, and/or the HIPD 1200 cause presentation of one or more avatars 904, digital representations of contacts 906, and virtual objects 908. As discussed below, the user 902 can interact with the one or more avatars 904, digital representations of the contacts 906, and virtual objects 908 via the wrist-wearable device 1000, the AR device 1100, and/or the HIPD 1200.

The user 902 can use any of the wrist-wearable device 1000, the AR device 1100, and/or the HIPD 1200 to provide user inputs. For example, the user 902 can perform one or more hand gestures that are detected by the wrist-wearable device 1000 (e.g., using one or more EMG sensors and/or IMUs, described below in reference to FIGS. 10A-10B) and/or AR device 1100 (e.g., using one or more image sensors or cameras, described below in reference to FIGS. 11A-11B) to provide a user input. Alternatively, or additionally, the user 902 can provide a user input via one or more touch surfaces of the wrist-wearable device 1000, the AR device 1100, and/or the HIPD 1200, and/or voice commands captured by a microphone of the wrist-wearable device 1000, the AR device 1100, and/or the HIPD 1200. In some embodiments, the wrist-wearable device 1000, the AR device 1100, and/or the HIPD 1200 include a digital assistant to help the user in providing a user input (e.g., completing a sequence of operations, suggesting different operations or commands, providing reminders, confirming a command). In some embodiments, the user 902 can provide a user input via one or more facial gestures and/or facial expressions. For example, cameras of the wrist-wearable device 1000, the AR device 1100, and/or the HIPD 1200 can track the user 902's eyes for navigating a user interface.

The wrist-wearable device 1000, the AR device 1100, and/or the HIPD 1200 can operate alone or in conjunction to allow the user 902 to interact with the AR environment. In some embodiments, the HIPD 1200 is configured to operate as a central hub or control center for the wrist-wearable device 1000, the AR device 1100, and/or another communicatively coupled device. For example, the user 902 can provide an input to interact with the AR environment at any of the wrist-wearable device 1000, the AR device 1100, and/or the HIPD 1200, and the HIPD 1200 can identify one or more back-end and front-end tasks to cause the performance of the requested interaction and distribute instructions to cause the performance of the one or more back-end and front-end tasks at the wrist-wearable device 1000, the AR device 1100, and/or the HIPD 1200. In some embodiments, a back-end task is a background-processing task that is not perceptible by the user (e.g., rendering content, decompression, compression, etc.), and a front-end task is a user-facing task that is perceptible to the user (e.g., presenting information to the user, providing feedback to the user, etc.)). As described below in reference to FIGS. 12A-12B, the HIPD 1200 can perform the back-end tasks and provide the wrist-wearable device 1000 and/or the AR device 1100 operational data corresponding to the performed back-end tasks such that the wrist-wearable device 1000 and/or the AR device 1100 can perform the front-end tasks. In this way, the HIPD 1200, which has more computational resources and greater thermal headroom than the wrist-wearable device 1000 and/or the AR device 1100, performs computationally intensive tasks and reduces the computer resource utilization and/or power usage of the wrist-wearable device 1000 and/or the AR device 1100.

In the example shown by the first AR system 900a, the HIPD 1200 identifies one or more back-end tasks and front-end tasks associated with a user request to initiate an AR video call with one or more other users (represented by the avatar 904 and the digital representation of the contact 906) and distributes instructions to cause the performance of the one or more back-end tasks and front-end tasks. In particular, the HIPD 1200 performs back-end tasks for processing and/or rendering image data (and other data) associated with the AR video call and provides operational data associated with the performed back-end tasks to the AR device 1100 such that the AR device 1100 performs front-end tasks for presenting the AR video call (e.g., presenting the avatar 904 and the digital representation of the contact 906).

In some embodiments, the HIPD 1200 can operate as a focal or anchor point for causing the presentation of information. This allows the user 902 to be generally aware of where information is presented. For example, as shown in the first AR system 900a, the avatar 904 and the digital representation of the contact 906 are presented above the HIPD 1200. In particular, the HIPD 1200 and the AR device 1100 operate in conjunction to determine a location for presenting the avatar 904 and the digital representation of the contact 906. In some embodiments, information can be presented within a predetermined distance from the HIPD 1200 (e.g., within five meters). For example, as shown in the first AR system 900a, virtual object 908 is presented on the desk some distance from the HIPD 1200. Similar to the above example, the HIPD 1200 and the AR device 1100 can operate in conjunction to determine a location for presenting the virtual object 908. Alternatively, in some embodiments, presentation of information is not bound by the HIPD 1200. More specifically, the avatar 904, the digital representation of the contact 906, and the virtual object 908 do not have to be presented within a predetermined distance of the HIPD 1200.

User inputs provided at the wrist-wearable device 1000, the AR device 1100, and/or the HIPD 1200 are coordinated such that the user can use any device to initiate, continue, and/or complete an operation. For example, the user 902 can provide a user input to the AR device 1100 to cause the AR device 1100 to present the virtual object 908 and, while the virtual object 908 is presented by the AR device 1100, the user 902 can provide one or more hand gestures via the wrist-wearable device 1000 to interact and/or manipulate the virtual object 908.

FIG. 9B shows the user 902 wearing the wrist-wearable device 1000 and the AR device 1100, and holding the HIPD 1200. In the second AR system 900b, the wrist-wearable device 1000, the AR device 1100, and/or the HIPD 1200 are used to receive and/or provide one or more messages to a contact of the user 902. In particular, the wrist-wearable device 1000, the AR device 1100, and/or the HIPD 1200 detect and coordinate one or more user inputs to initiate a messaging application and prepare a response to a received message via the messaging application.

In some embodiments, the user 902 initiates, via a user input, an application on the wrist-wearable device 1000, the AR device 1100, and/or the HIPD 1200 that causes the application to initiate on at least one device. For example, in the second AR system 900b the user 902 performs a hand gesture associated with a command for initiating a messaging application (represented by messaging user interface 912); the wrist-wearable device 1000 detects the hand gesture; and, based on a determination that the user 902 is wearing AR device 1100, causes the AR device 1100 to present a messaging user interface 912 of the messaging application. The AR device 1100 can present the messaging user interface 912 to the user 902 via its display (e.g., as shown by user 902's field of view 910). In some embodiments, the application is initiated and can be run on the device (e.g., the wrist-wearable device 1000, the AR device 1100, and/or the HIPD 1200) that detects the user input to initiate the application, and the device provides another device operational data to cause the presentation of the messaging application. For example, the wrist-wearable device 1000 can detect the user input to initiate a messaging application, initiate and run the messaging application, and provide operational data to the AR device 1100 and/or the HIPD 1200 to cause presentation of the messaging application. Alternatively, the application can be initiated and run at a device other than the device that detected the user input. For example, the wrist-wearable device 1000 can detect the hand gesture associated with initiating the messaging application and cause the HIPD 1200 to run the messaging application and coordinate the presentation of the messaging application.

Further, the user 902 can provide a user input provided at the wrist-wearable device 1000, the AR device 1100, and/or the HIPD 1200 to continue and/or complete an operation initiated at another device. For example, after initiating the messaging application via the wrist-wearable device 1000 and while the AR device 1100 presents the messaging user interface 912, the user 902 can provide an input at the HIPD 1200 to prepare a response (e.g., shown by the swipe gesture performed on the HIPD 1200). The user 902's gestures performed on the HIPD 1200 can be provided and/or displayed on another device. For example, the user 902's swipe gestures performed on the HIPD 1200 are displayed on a virtual keyboard of the messaging user interface 912 displayed by the AR device 1100.

In some embodiments, the wrist-wearable device 1000, the AR device 1100, the HIPD 1200, and/or other communicatively coupled devices can present one or more notifications to the user 902. The notification can be an indication of a new message, an incoming call, an application update, a status update, etc. The user 902 can select the notification via the wrist-wearable device 1000, the AR device 1100, or the HIPD 1200 and cause presentation of an application or operation associated with the notification on at least one device. For example, the user 902 can receive a notification that a message was received at the wrist-wearable device 1000, the AR device 1100, the HIPD 1200, and/or other communicatively coupled device and provide a user input at the wrist-wearable device 1000, the AR device 1100, and/or the HIPD 1200 to review the notification, and the device detecting the user input can cause an application associated with the notification to be initiated and/or presented at the wrist-wearable device 1000, the AR device 1100, and/or the HIPD 1200.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 1100 can present to the user 902 game application data and the HIPD 1200 can use a controller to provide inputs to the game. Similarly, the user 902 can use the wrist-wearable device 1000 to initiate a camera of the AR device 1100, and the user can use the wrist-wearable device 1000, the AR device 1100, and/or the HIPD 1200 to manipulate the image capture (e.g., zoom in or out, apply filters, etc.) and capture image data.

Turning to FIGS. 9C-1 and 9C-2, the user 902 is shown wearing the wrist-wearable device 1000 and a VR device 1110, and holding the HIPD 1200. In the third AR system 900c, the wrist-wearable device 1000, the VR device 1110, and/or the HIPD 1200 are used to interact within an AR environment, such as a VR game or other AR application. While the VR device 1110 present a representation of a VR game (e.g., first AR game environment 920) to the user 902, the wrist-wearable device 1000, the VR device 1110, and/or the HIPD 1200 detect and coordinate one or more user inputs to allow the user 902 to interact with the VR game.

In some embodiments, the user 902 can provide a user input via the wrist-wearable device 1000, the VR device 1110, and/or the HIPD 1200 that causes an action in a corresponding AR environment. For example, the user 902 in the third AR system 900c (shown in FIG. 9C-1) raises the HIPD 1200 to prepare for a swing in the first AR game environment 920. The VR device 1110, responsive to the user 902 raising the HIPD 1200, causes the AR representation of the user 922 to perform a similar action (e.g., raise a virtual object, such as a virtual sword 924). In some embodiments, each device uses respective sensor data and/or image data to detect the user input and provide an accurate representation of the user 902's motion. For example, image sensors 1258 (e.g., SLAM cameras or other cameras discussed below in FIGS. 12A and 12B) of the HIPD 1200 can be used to detect a position of the 1200 relative to the user 902's body such that the virtual object can be positioned appropriately within the first AR game environment 920; sensor data from the wrist-wearable device 1000 can be used to detect a velocity at which the user 902 raises the HIPD 1200 such that the AR representation of the user 922 and the virtual sword 924 are synchronized with the user 902's movements; and image sensors 1126 (FIGS. 11A-11C) of the VR device 1110 can be used to represent the user 902's body, boundary conditions, or real-world objects within the first AR game environment 920.

In FIG. 9C-2, the user 902 performs a downward swing while holding the HIPD 1200. The user 902's downward swing is detected by the wrist-wearable device 1000, the VR device 1110, and/or the HIPD 1200 and a corresponding action is performed in the first AR game environment 920. In some embodiments, the data captured by each device is used to improve the user's experience within the AR environment. For example, sensor data of the wrist-wearable device 1000 can be used to determine a speed and/or force at which the downward swing is performed and image sensors of the HIPD 1200 and/or the VR device 1110 can be used to determine a location of the swing and how it should be represented in the first AR game environment 920, which, in turn, can be used as inputs for the AR environment (e.g., game mechanics, which can use detected speed, force, locations, and/or aspects of the user 902's actions to classify a user's inputs (e.g., user performs a light strike, hard strike, critical strike, glancing strike, miss) or calculate an output (e.g., amount of damage)).

While the wrist-wearable device 1000, the VR device 1110, and/or the HIPD 1200 are described as detecting user inputs, in some embodiments, user inputs are detected at a single device (with the single device being responsible for distributing signals to the other devices for performing the user input). For example, the HIPD 1200 can operate an application for generating the first AR game environment 920 and provide the VR device 1110 with corresponding data for causing the presentation of the first AR game environment 920, as well as detect the 902's movements (while holding the HIPD 1200) to cause the performance of corresponding actions within the first AR game environment 920. Additionally or alternatively, in some embodiments, operational data (e.g., sensor data, image data, application data, device data, and/or other data) of one or more devices is provide to a single device (e.g., the HIPD 1200) to process the operational data and cause respective devices to perform an action associated with processed operational data.

Having discussed example AR systems, devices for interacting with such AR systems, and other computing systems more generally, will now be discussed in greater detail below. Some definitions of devices and components that can be included in some or all of the example devices discussed below are defined here for ease of reference. A skilled artisan will appreciate that certain types of the components described below may be more suitable for a particular set of devices, and less suitable for a different set of devices. But subsequent reference to the components defined here should be considered to be encompassed by the definitions provided.

In some embodiments discussed below example devices and systems, including electronic devices and systems, will be discussed. Such example devices and systems are not intended to be limiting, and one of skill in the art will understand that alternative devices and systems to the example devices and systems described herein may be used to perform the operations and construct the systems and device that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

### Example Wrist-Wearable Devices

FIGS. 10A and 10B illustrate an example wrist-wearable device 1000, in accordance with some embodiments. The wrist-wearable device 1000 is an instance of the wearable device described in reference to FIG. 8 herein, such that the wrist-wearable devices should be understood to have the features of the wrist-wearable device 1000. FIG. 10A illustrates components of the wrist-wearable device 1000, which can be used individually or in combination, including combinations that include other electronic devices and/or electronic components.

FIG. 10A shows a wearable band 1010 and a watch body 1020 (or capsule) being coupled, as discussed below, to form the wrist-wearable device 1000. The wrist-wearable device 1000 can perform various functions and/or operations associated with navigating through user interfaces and selectively opening applications, as well as the functions and/or operations described above with reference to FIG. 8 (e.g., assist in calibrating a head-wearable device 108).

As will be described in more detail below, operations executed by the wrist-wearable device 1000 can include (i) presenting content to a user (e.g., displaying visual content via a display 1005); (ii) detecting (e.g., sensing) user input (e.g., sensing a touch on peripheral button 1023 and/or at a touch screen of the display 1005, a hand gesture detected by sensors (e.g., biopotential sensors)); (iii) sensing biometric data via one or more sensors 1013 (e.g., neuromuscular signals, heart rate, temperature, sleep, etc.); messaging (e.g., text, speech, video, etc.); image capture via one or more imaging devices or cameras 1025; wireless communications (e.g., cellular, near field, Wi-Fi, personal area network, etc.); location determination; financial transactions; providing haptic feedback; alarms; notifications; biometric authentication; health monitoring; sleep monitoring.

The above-example functions can be executed independently in the watch body 1020, independently in the wearable band 1010, and/or via an electronic communication between the watch body 1020 and the wearable band 1010. In some embodiments, functions can be executed on the wrist-wearable device 1000 while an AR environment is being presented (e.g., via one of the AR systems 900a to 900c). As the skilled artisan will appreciate upon reading the descriptions provided herein, the novel wearable devices described herein can be used with other types of AR environments.

The wearable band 1010 can be configured to be worn by a user such that an inner (or inside) surface of the wearable structure 1011 of the wearable band 1010 is in contact with the user's skin. When worn by a user, sensors 1013 contact the user's skin. The sensors 1013 can sense biometric data such as a user's heart rate, saturated oxygen level, temperature, sweat level, neuromuscular signal sensors, or a combination thereof. The sensors 1013 can also sense data about a user's environment, including a user's motion, altitude, location, orientation, gait, acceleration, position, or a combination thereof. In some embodiments, the sensors 1013 are configured to track a position and/or motion of the wearable band 1010. The one or more sensors 1013 can include any of the sensors defined above and/or discussed below with respect to FIG. 10B.

The one or more sensors 1013 can be distributed on an inside and/or an outside surface of the wearable band 1010. In some embodiments, the one or more sensors 1013 are uniformly spaced along the wearable band 1010. Alternatively, in some embodiments, the one or more sensors 1013 are positioned at distinct points along the wearable band 1010. As shown in FIG. 10A, the one or more sensors 1013 can be the same or distinct. For example, in some embodiments, the one or more sensors 1013 can be shaped as a pill (e.g., sensor 1013a), an oval, a circle a square, an oblong (e.g., sensor 1013c) and/or any other shape that maintains contact with the user's skin (e.g., such that neuromuscular signal and/or other biometric data can be accurately measured at the user's skin). In some embodiments, the one or more sensors 1013 are aligned to form pairs of sensors (e.g., for sensing neuromuscular signals based on differential sensing within each respective sensor). For example, sensor 1013b is aligned with an adjacent sensor to form sensor pair 1014a and sensor 1013d is aligned with an adjacent sensor to form sensor pair 1014b. In some embodiments, the wearable band 1010 does not have a sensor pair. Alternatively, in some embodiments, the wearable band 1010 has a predetermined number of sensor pairs (one pair of sensors, three pairs of sensors, four pairs of sensors, six pairs of sensors, sixteen pairs of sensors, etc.).

The wearable band 1010 can include any suitable number of sensors 1013. In some embodiments, the number and arrangements of sensors 1013 depend on the particular application for which the wearable band 1010 is used. For instance, a wearable band 1010 configured as an armband, wristband, or chest-band may include a plurality of sensors 1013 with different number of sensors 1013 and different arrangement for each use case, such as medical use cases, compared to gaming or general day-to-day use cases.

In accordance with some embodiments, the wearable band 1010 further includes an electrical ground electrode and a shielding electrode. The electrical ground and shielding electrodes, like the sensors 1013, can be distributed on the inside surface of the wearable band 1010 such that they contact a portion of the user's skin. For example, the electrical ground and shielding electrodes can be at an inside surface of coupling mechanism 1016 or an inside surface of a wearable structure 1011. The electrical ground and shielding electrodes can be formed and/or use the same components as the sensors 1013. In some embodiments, the wearable band 1010 includes more than one electrical ground electrode and more than one shielding electrode.

The sensors 1013 can be formed as part of the wearable structure 1011 of the wearable band 1010. In some embodiments, the sensors 1013 are flush or substantially flush with the wearable structure 1011 such that they do not extend beyond the surface of the wearable structure 1011. While flush with the wearable structure 1011, the sensors 1013 are still configured to contact the user's skin (e.g., via a skin-contacting surface). Alternatively, in some embodiments, the sensors 1013 extend beyond the wearable structure 1011 a predetermined distance (e.g., 0.1 mm to 2 mm) to make contact and depress into the user's skin. In some embodiments, the sensors 1013 are coupled to an actuator (not shown) configured to adjust an extension height (e.g., a distance from the surface of the wearable structure 1011) of the sensors 1013 such that the sensors 1013 make contact and depress into the user's skin. In some embodiments, the actuators adjust the extension height between 0.01 mm to 1.2 mm. This allows the user to customize the positioning of the sensors 1013 to improve the overall comfort of the wearable band 1010 when worn while still allowing the sensors 1013 to contact the user's skin. In some embodiments, the sensors 1013 are indistinguishable from the wearable structure 1011 when worn by the user.

The wearable structure 1011 can be formed of an elastic material, elastomers, etc., configured to be stretched and fitted to be worn by the user. In some embodiments, the wearable structure 1011 is a textile or woven fabric. As described above, the sensors 1013 can be formed as part of a wearable structure 1011. For example, the sensors 1013 can be molded into the wearable structure 1011 or be integrated into a woven fabric (e.g., the sensors 1013 can be sewn into the fabric and mimic the pliability of fabric (e.g., the sensors 1013 can be constructed from a series of woven strands of fabric)).

The wearable structure 1011 can include flexible electronic connectors that interconnect the sensors 1013, the electronic circuitry, and/or other electronic components (described below in reference to FIG. 10B) that are enclosed in the wearable band 1010. In some embodiments, the flexible electronic connectors are configured to interconnect the sensors 1013, the electronic circuitry, and/or other electronic components of the wearable band 1010 with respective sensors and/or other electronic components of another electronic device (e.g., watch body 1020). The flexible electronic connectors are configured to move with the wearable structure 1011 such that the user adjustment to the wearable structure 1011 (e.g., resizing, pulling, folding, etc.) does not stress or strain the electrical coupling of components of the wearable band 1010.

As described above, the wearable band 1010 is configured to be worn by a user. In particular, the wearable band 1010 can be shaped or otherwise manipulated to be worn by a user. For example, the wearable band 1010 can be shaped to have a substantially circular shape such that it can be configured to be worn on the user's lower arm or wrist. Alternatively, the wearable band 1010 can be shaped to be worn on another body part of the user, such as the user's upper arm (e.g., around a bicep), forearm, chest, legs, etc. The wearable band 1010 can include a retaining mechanism 1012 (e.g., a buckle, a hook and loop fastener, etc.) for securing the wearable band 1010 to the user's wrist or other body part. While the wearable band 1010 is worn by the user, the sensors 1013 sense data (referred to as sensor data) from the user's skin. In particular, the sensors 1013 of the wearable band 1010 obtain (e.g., sense and record) neuromuscular signals.

The sensed data (e.g., sensed neuromuscular signals) can be used to detect and/or determine the user's intention to perform certain motor actions. In particular, the sensors 1013 sense and record neuromuscular signals from the user as the user performs muscular activations (e.g., movements, gestures, etc.). The detected and/or determined motor actions (e.g., phalange (or digits) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on the display 1005 of the wrist-wearable device 1000 and/or can be transmitted to a device responsible for rendering an artificial-reality environment (e.g., a head-mounted display) to perform an action in an associated artificial-reality environment, such as to control the motion of a virtual device displayed to the user. The muscular activations performed by the user can include static gestures, such as placing the user's hand palm down on a table; dynamic gestures, such as grasping a physical or virtual object; and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by the sensors 1013 can be used to provide a user with an enhanced interaction with a physical object (e.g., devices communicatively coupled with the wearable band 1010) and/or a virtual object in an artificial-reality application generated by an artificial-reality system (e.g., user interface objects presented on the display 1005 or another computing device (e.g., a smartphone)).

In some embodiments, the wearable band 1010 includes one or more haptic devices 1046 (FIG. 10B; e.g., a vibratory haptic actuator) that are configured to provide haptic feedback (e.g., a cutaneous and/or kinesthetic sensation, etc.) to the user's skin. The sensors 1013, and/or the haptic devices 1046 can be configured to operate in conjunction with multiple applications including, without limitation, health monitoring, social media, games, and artificial reality (e.g., the applications associated with artificial reality).

The wearable band 1010 can also include coupling mechanism 1016 (e.g., a cradle or a shape of the coupling mechanism can correspond to shape of the watch body 1020 of the wrist-wearable device 1000) for detachably coupling a capsule (e.g., a computing unit) or watch body 1020 (via a coupling surface of the watch body 1020) to the wearable band 1010. In particular, the coupling mechanism 1016 can be configured to receive a coupling surface proximate to the bottom side of the watch body 1020 (e.g., a side opposite to a front side of the watch body 1020 where the display 1005 is located), such that a user can push the watch body 1020 downward into the coupling mechanism 1016 to attach the watch body 1020 to the coupling mechanism 1016. In some embodiments, the coupling mechanism 1016 can be configured to receive a top side of the watch body 1020 (e.g., a side proximate to the front side of the watch body 1020 where the display 1005 is located) that is pushed upward into the cradle, as opposed to being pushed downward into the coupling mechanism 1016. In some embodiments, the coupling mechanism 1016 is an integrated component of the wearable band 1010 such that the wearable band 1010 and the coupling mechanism 1016 are a single unitary structure. In some embodiments, the coupling mechanism 1016 is a type of frame or shell that allows the watch body 1020 coupling surface to be retained within or on the wearable band 1010 coupling mechanism 1016 (e.g., a cradle, a tracker band, a support base, a clasp, etc.).

The coupling mechanism 1016 can allow for the watch body 1020 to be detachably coupled to the wearable band 1010 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 1020 to the wearable band 1010 and to decouple the watch body 1020 from the wearable band 1010. For example, a user can twist, slide, turn, push, pull, or rotate the watch body 1020 relative to the wearable band 1010, or a combination thereof, to attach the watch body 1020 to the wearable band 1010 and to detach the watch body 1020 from the wearable band 1010. Alternatively, as discussed below, in some embodiments, the watch body 1020 can be decoupled from the wearable band 1010 by actuation of the release mechanism 1029.

The wearable band 1010 can be coupled with a watch body 1020 to increase the functionality of the wearable band 1010 (e.g., converting the wearable band 1010 into a wrist-wearable device 1000, adding an additional computing unit and/or battery to increase computational resources and/or a battery life of the wearable band 1010, adding additional sensors to improve sensed data, etc.). As described above, the wearable band 1010 (and the coupling mechanism 1016) is configured to operate independently (e.g., execute functions independently) from watch body 1020. For example, the coupling mechanism 1016 can include one or more sensors 1013 that contact a user's skin when the wearable band 1010 is worn by the user and provide sensor data for determining control commands.

A user can detach the watch body 1020 (or capsule) from the wearable band 1010 in order to reduce the encumbrance of the wrist-wearable device 1000 to the user. For embodiments in which the watch body 1020 is removable, the watch body 1020 can be referred to as a removable structure, such that in these embodiments the wrist-wearable device 1000 includes a wearable portion (e.g., the wearable band 1010) and a removable structure (the watch body 1020).

Turning to the watch body 1020, the watch body 1020 can have a substantially rectangular or circular shape. The watch body 1020 is configured to be worn by the user on their wrist or on another body part. More specifically, the watch body 1020 is sized to be easily carried by the user, attached on a portion of the user's clothing, and/or coupled to the wearable band 1010 (forming the wrist-wearable device 1000). As described above, the watch body 1020 can have a shape corresponding to the coupling mechanism 1016 of the wearable band 1010. In some embodiments, the watch body 1020 includes a single release mechanism 1029 or multiple release mechanisms (e.g., two release mechanisms 1029 positioned on opposing sides of the watch body 1020, such as spring-loaded buttons) for decoupling the watch body 1020 and the wearable band 1010. The release mechanism 1029 can include, without limitation, a button, a knob, a plunger, a handle, a lever, a fastener, a clasp, a dial, a latch, or a combination thereof.

A user can actuate the release mechanism 1029 by pushing, turning, lifting, depressing, shifting, or performing other actions on the release mechanism 1029. Actuation of the release mechanism 1029 can release (e.g., decouple) the watch body 1020 from the coupling mechanism 1016 of the wearable band 1010, allowing the user to use the watch body 1020 independently from wearable band 1010, and vice versa. For example, decoupling the watch body 1020 from the wearable band 1010 can allow the user to capture images using rear-facing camera 1025B. Although the coupling mechanism 1016 is shown positioned at a corner of watch body 1020, the release mechanism 1029 can be positioned anywhere on watch body 1020 that is convenient for the user to actuate. In addition, in some embodiments, the wearable band 1010 can also include a respective release mechanism for decoupling the watch body 1020 from the coupling mechanism 1016. In some embodiments, the release mechanism 1029 is optional and the watch body 1020 can be decoupled from the coupling mechanism 1016 as described above (e.g., via twisting, rotating, etc.).

The watch body 1020 can include one or more peripheral buttons 1023 and 1027 for performing various operations at the watch body 1020. For example, the peripheral buttons 1023 and 1027 can be used to turn on or wake (e.g., transition from a sleep state to an active state) the display 1005, unlock the watch body 1020, increase or decrease a volume, increase or decrease brightness, interact with one or more applications, interact with one or more user interfaces, etc. Additionally, or alternatively, in some embodiments, the display 1005 operates as a touch screen and allows the user to provide one or more inputs for interacting with the watch body 1020.

In some embodiments, the watch body 1020 includes one or more sensors 1021. The sensors 1021 of the watch body 1020 can be the same or distinct from the sensors 1013 of the wearable band 1010. The sensors 1021 of the watch body 1020 can be distributed on an inside and/or an outside surface of the watch body 1020. In some embodiments, the sensors 1021 are configured to contact a user's skin when the watch body 1020 is worn by the user. For example, the sensors 1021 can be placed on the bottom side of the watch body 1020 and the coupling mechanism 1016 can be a cradle with an opening that allows the bottom side of the watch body 1020 to directly contact the user's skin. Alternatively, in some embodiments, the watch body 1020 does not include sensors that are configured to contact the user's skin (e.g., including sensors internal and/or external to the watch body 1020 that configured to sense data of the watch body 1020 and the watch body 1020's surrounding environment). In some embodiments, the sensors 1013 are configured to track a position and/or motion of the watch body 1020.

The watch body 1020 and the wearable band 1010 can share data using a wired communication method (e.g., a Universal Asynchronous Receiver/Transmitter (UART), a USB transceiver, etc.) and/or a wireless communication method (e.g., near field communication, Bluetooth, etc.). For example, the watch body 1020 and the wearable band 1010 can share data sensed by the sensors 1013 and 1021, as well as application—and device-specific information (e.g., active and/or available applications), output devices (e.g., display, speakers, etc.), input devices (e.g., touch screen, microphone, imaging sensors, etc.).

In some embodiments, the watch body 1020 can include, without limitation, a front-facing camera 1025A and/or a rear-facing camera 1025B, sensors 1021 (e.g., a biometric sensor, an IMU sensor, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 1063; FIG. 10B), a touch sensor, a sweat sensor, etc.). In some embodiments, the watch body 1020 can include one or more haptic devices 1076 (FIG. 10B; a vibratory haptic actuator) that is configured to provide haptic feedback (e.g., a cutaneous and/or kinesthetic sensation, etc.) to the user. The sensors 1021 and/or the haptic device 1076 can also be configured to operate in conjunction with multiple applications including, without limitation, health-monitoring applications, social media applications, game applications, and artificial-reality applications (e.g., the applications associated with artificial reality).

As described above, the watch body 1020 and the wearable band 1010, when coupled, can form the wrist-wearable device 1000. When coupled, the watch body 1020 and wearable band 1010 operate as a single device to execute functions (operations, detections, communications, etc.) described herein. In some embodiments, each device is provided with particular instructions for performing the one or more operations of the wrist-wearable device 1000. For example, in accordance with a determination that the watch body 1020 does not include neuromuscular signal sensors, the wearable band 1010 can include alternative instructions for performing associated instructions (e.g., providing sensed neuromuscular signal data to the watch body 1020 via a different electronic device). Operations of the wrist-wearable device 1000 can be performed by the watch body 1020 alone or in conjunction with the wearable band 1010 (e.g., via respective processors and/or hardware components) and vice versa. In some embodiments, operations of the wrist-wearable device 1000, the watch body 1020, and/or the wearable band 1010 can be performed in conjunction with one or more processors and/or hardware components of another communicatively coupled device (e.g., the HIPD 1200; FIGS. 12A-12B).

As described below with reference to the block diagram of FIG. 10B, the wearable band 1010 and/or the watch body 1020 can each include independent resources required to independently execute functions. For example, the wearable band 1010 and/or the watch body 1020 can each include a power source (e.g., a battery), a memory, data storage, a processor (e.g., a central processing unit (CPU)), communications, a light source, and/or input/output devices.

FIG. 10B shows block diagrams of a computing system 1030 corresponding to the wearable band 1010, and a computing system 1060 corresponding to the watch body 1020, according to some embodiments. A computing system of the wrist-wearable device 1000 includes a combination of components of the wearable band computing system 1030 and the watch body computing system 1060, in accordance with some embodiments.

The watch body 1020 and/or the wearable band 1010 can include one or more components shown in watch body computing system 1060. In some embodiments, a single integrated circuit includes all or a substantial portion of the components of the watch body computing system 1060 are included in a single integrated circuit. Alternatively, in some embodiments, components of the watch body computing system 1060 are included in a plurality of integrated circuits that are communicatively coupled. In some embodiments, the watch body computing system 1060 is configured to couple (e.g., via a wired or wireless connection) with the wearable band computing system 1030, which allows the computing systems to share components, distribute tasks, and/or perform other operations described herein (individually or as a single device).

The watch body computing system 1060 can include one or more processors 1079, a controller 1077, a peripherals interface 1061, a power system 1095, and memory (e.g., a memory 1080), each of which are defined above and described in more detail below.

The power system 1095 can include a charger input 1096, a power-management integrated circuit (PMIC) 1097, and a battery 1098, each are which are defined above. In some embodiments, a watch body 1020 and a wearable band 1010 can have respective charger inputs (e.g., charger input 1096 and 1057), respective batteries (e.g., battery 1098 and 1059), and can share power with each other (e.g., the watch body 1020 can power and/or charge the wearable band 1010, and vice versa). Although watch body 1020 and/or the wearable band 1010 can include respective charger inputs, a single charger input can charge both devices when coupled. The watch body 1020 and the wearable band 1010 can receive a charge using a variety of techniques. In some embodiments, the watch body 1020 and the wearable band 1010 can use a wired charging assembly (e.g., power cords) to receive the charge. Alternatively, or in addition, the watch body 1020 and/or the wearable band 1010 can be configured for wireless charging. For example, a portable charging device can be designed to mate with a portion of watch body 1020 and/or wearable band 1010 and wirelessly deliver usable power to a battery of watch body 1020 and/or wearable band 1010. The watch body 1020 and the wearable band 1010 can have independent power systems (e.g., power system 1095 and 1056) to enable each to operate independently. The watch body 1020 and wearable band 1010 can also share power (e.g., one can charge the other) via respective PMICs (e.g., PMICs 1097 and 1058) that can share power over power and ground conductors and/or over wireless charging antennas.

In some embodiments, the peripherals interface 1061 can include one or more sensors 1021, many of which listed below are defined above. The sensors 1021 can include one or more coupling sensors 1062 for detecting when the watch body 1020 is coupled with another electronic device (e.g., a wearable band 1010). The sensors 1021 can include imaging sensors 1063 (one or more of the cameras 1025 and/or separate imaging sensors 1063 (e.g., thermal-imaging sensors)). In some embodiments, the sensors 1021 include one or more SpO2 sensors 1064. In some embodiments, the sensors 1021 include one or more biopotential-signal sensors (e.g., EMG sensors 1065, which may be disposed on a user-facing portion of the watch body 1020 and/or the wearable band 1010). In some embodiments, the sensors 1021 include one or more capacitive sensors 1066. In some embodiments, the sensors 1021 include one or more heart rate sensors 1067. In some embodiments, the sensors 1021 include one or more IMUs 1068. In some embodiments, one or more IMUs 1068 can be configured to detect movement of a user's hand or other location that the watch body 1020 is placed or held.

In some embodiments, the peripherals interface 1061 includes an NFC component 1069, a global-position system (GPS) component 1070, a long-term evolution (LTE) component 1071, and/or a Wi-Fi and/or Bluetooth communication component 1072. In some embodiments, the peripherals interface 1061 includes one or more buttons 1073 (e.g., the peripheral buttons 1023 and 1027 in FIG. 10A), which, when selected by a user, cause operations to be performed at the watch body 1020. In some embodiments, the peripherals interface 1061 includes one or more indicators, such as a light emitting diode (LED), to provide a user with visual indicators (e.g., message received, low battery, an active microphone, and/or a camera, etc.).

The watch body 1020 can include at least one display 1005 for displaying visual representations of information or data to the user, including user-interface elements and/or three-dimensional (3D) virtual objects. The display can also include a touch screen for inputting user inputs, such as touch gestures, swipe gestures, and the like. The watch body 1020 can include at least one speaker 1074 and at least one microphone 1075 for providing audio signals to the user and receiving audio input from the user. The user can provide user inputs through the microphone 1075 and can also receive audio output from the speaker 1074 as part of a haptic event provided by the haptic controller 1078. The watch body 1020 can include at least one camera 1025, including a front-facing camera 1025A and a rear-facing camera 1025B. The cameras 1025 can include ultra-wide-angle cameras, wide-angle cameras, fish-eye cameras, spherical cameras, telephoto cameras, a depth-sensing cameras, or other types of cameras.

The watch body computing system 1060 can include one or more haptic controllers 1078 and associated componentry (e.g., haptic devices 1076) for providing haptic events at the watch body 1020 (e.g., a vibrating sensation or audio output in response to an event at the watch body 1020). The haptic controllers 1078 can communicate with one or more haptic devices 1076, such as electroacoustic devices, including a speaker of the one or more speakers 1074 and/or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). The haptic controller 1078 can provide haptic events to respective haptic actuators that are capable of being sensed by a user of the watch body 1020. In some embodiments, the one or more haptic controllers 1078 can receive input signals from an application of the applications 1082.

In some embodiments, the computer system 1030 and/or the computer system 1060 can include memory 1080, which can be controlled by a memory controller of the one or more controllers 1077 and/or one or more processors 1079. In some embodiments, software components stored in the memory 1080 include one or more applications 1082 configured to perform operations at the watch body 1020. In some embodiments, the one or more applications 1082 include games, word processors, messaging applications, calling applications, web browsers, social media applications, media streaming applications, financial applications, calendars, clocks, etc. In some embodiments, software components stored in the memory 1080 include one or more communication interface modules 1083 as defined above. In some embodiments, software components stored in the memory 1080 include one or more graphics modules 1084 for rendering, encoding, and/or decoding audio and/or visual data; and one or more data management modules 1085 for collecting, organizing, and/or providing access to the data 1087 stored in memory 1080. In some embodiments, software components stored in the memory 1080 include a calibration module 1086A, which is configured to perform the features described above in reference to FIGS. 1A-8 (e.g., use data received via a case 102 and/or head-wearable device 108 to determine an amount of disparity and/or calibrate the head-wearable device 108). In some embodiments, one or more of applications 1082 and/or one or more modules can work in conjunction with one another to perform various tasks at the watch body 1020.

In some embodiments, software components stored in the memory 1080 can include one or more operating systems 1081 (e.g., a Linux-based operating system, an Android operating system, etc.). The memory 1080 can also include data 1087. The data 1087 can include profile data 1088A, sensor data 1089A, media content data 1090, application data 1091, and calibration data 1092A, which stores data related to the performance of the features described above in reference to FIGS. 1A-8 (e.g., one or more algorithms for determining an amount of disparity, position criteria, calibration criteria, etc.).

It should be appreciated that the watch body computing system 1060 is an example of a computing system within the watch body 1020, and that the watch body 1020 can have more or fewer components than shown in the watch body computing system 1060, combine two or more components, and/or have a different configuration and/or arrangement of the components. The various components shown in watch body computing system 1060 are implemented in hardware, software, firmware, or a combination thereof, including one or more signal processing and/or application-specific integrated circuits.

Turning to the wearable band computing system 1030, one or more components that can be included in the wearable band 1010 are shown. The wearable band computing system 1030 can include more or fewer components than shown in the watch body computing system 1060, combine two or more components, and/or have a different configuration and/or arrangement of some or all of the components. In some embodiments, all, or a substantial portion of the components of the wearable band computing system 1030 are included in a single integrated circuit. Alternatively, in some embodiments, components of the wearable band computing system 1030 are included in a plurality of integrated circuits that are communicatively coupled. As described above, in some embodiments, the wearable band computing system 1030 is configured to couple (e.g., via a wired or wireless connection) with the watch body computing system 1060, which allows the computing systems to share components, distribute tasks, and/or perform other operations described herein (individually or as a single device).

The wearable band computing system 1030, similar to the watch body computing system 1060, can include one or more processors 1049, one or more controllers 1047 (including one or more haptics controller 1048), a peripherals interface 1031 that can include one or more sensors 1013 and other peripheral devices, power source (e.g., a power system 1056), and memory (e.g., a memory 1050) that includes an operating system (e.g., an operating system 1051), data (e.g., data 1054 including profile data 1088B, sensor data 1089B, calibration data 1092B, etc.), and one or more modules (e.g., a communications interface module 1052, a data management module 1053, a calibration module 1086B, etc.).

The one or more sensors 1013 can be analogous to sensors 1021 of the computer system 1060 in light of the definitions above. For example, sensors 1013 can include one or more coupling sensors 1032, one or more SpO2 sensors 1034, one or more EMG sensors 1035, one or more capacitive sensors 1036, one or more heart rate sensors 1037, and one or more IMU sensors 1038.

The peripherals interface 1031 can also include other components analogous to those included in the peripheral interface 1061 of the computer system 1060, including an NFC component 1039, a GPS component 1040, an LTE component 1041, a Wi-Fi and/or Bluetooth communication component 1042, and/or one or more haptic devices 1076 as described above in reference to peripherals interface 1061. In some embodiments, the peripherals interface 1031 includes one or more buttons 1043, a display 1033, a speaker 1044, a microphone 1045, and a camera 1055. In some embodiments, the peripherals interface 1031 includes one or more indicators, such as an LED.

It should be appreciated that the wearable band computing system 1030 is an example of a computing system within the wearable band 1010, and that the wearable band 1010 can have more or fewer components than shown in the wearable band computing system 1030, combine two or more components, and/or have a different configuration and/or arrangement of the components. The various components shown in wearable band computing system 1030 can be implemented in one or a combination of hardware, software, and firmware, including one or more signal processing and/or application-specific integrated circuits.

The wrist-wearable device 1000 with respect to FIG. 10A is an example of the wearable band 1010 and the watch body 1020 coupled, so the wrist-wearable device 1000 will be understood to include the components shown and described for the wearable band computing system 1030 and the watch body computing system 1060. In some embodiments, wrist-wearable device 1000 has a split architecture (e.g., a split mechanical architecture or a split electrical architecture) between the watch body 1020 and the wearable band 1010. In other words, all of the components shown in the wearable band computing system 1030 and the watch body computing system 1060 can be housed or otherwise disposed in a combined watch device 1000, or within individual components of the watch body 1020, wearable band 1010, and/or portions thereof (e.g., a coupling mechanism 1016 of the wearable band 1010).

The techniques described above can be used with any device for sensing neuromuscular signals, including the arm-wearable devices of FIG. 10A-10B, but could also be used with other types of wearable devices for sensing neuromuscular signals (such as body-wearable or head-wearable devices that might have neuromuscular sensors closer to the brain or spinal column).

In some embodiments, a wrist-wearable device 1000 can be used in conjunction with a head-wearable device described below (e.g., AR device 1100 and VR device 1110) and/or an HIPD 1200, and the wrist-wearable device 1000 can also be configured to be used to allow a user to control aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable device, attention will now be turned to example head-wearable devices, such AR device 1100 and VR device 1110.

### Example Head-Wearable Devices

FIGS. 11A, 11B-1, 11B-2, and 11C show example head-wearable devices, in accordance with some embodiments. Head-wearable devices can include, but are not limited to, AR devices 1110 (e.g., AR or smart eyewear devices, such as smart glasses, smart monocles, smart contacts, etc.), VR devices 1110 (e.g., VR headsets, head-mounted displays (HMD) s, etc.), or other ocularly coupled devices. The AR devices 1100 and the VR devices 1110 are instances of the head-wearable devices 108 described in reference to FIGS. 1A-8 herein, such that the head-wearable device 108 should be understood to have the features of the AR devices 1100 and/or the VR devices 1110, and vice versa. The AR devices 1100 and the VR devices 1110 can perform various functions and/or operations associated with navigating through user interfaces and selectively opening applications, as well as the functions and/or operations described above with reference to FIGS. 1A-8.

In some embodiments, an AR system (e.g., AR systems 900a-900c; FIGS. 9A-9C-2) includes an AR device 1100 (as shown in FIG. 11A) and/or VR device 1110 (as shown in FIGS. 11B-1-B-2). In some embodiments, the AR device 1100 and the VR device 1110 can include one or more analogous components (e.g., components for presenting interactive artificial-reality environments, such as processors, memory, and/or presentation devices, including one or more displays and/or one or more waveguides), some of which are described in more detail with respect to FIG. 11C. The head-wearable devices can use display projectors (e.g., display projector assemblies 1107A and 1107B) and/or waveguides for projecting representations of data to a user. Some embodiments of head-wearable devices do not include displays.

FIG. 11A shows an example visual depiction of the AR device 1100 (e.g., which may also be described herein as augmented-reality glasses and/or smart glasses). The AR device 1100 can work in conjunction with additional electronic components that are not shown in FIGS. 11A, such as a wearable accessory device and/or an intermediary processing device, in electronic communication or otherwise configured to be used in conjunction with the AR device 1100. In some embodiments, the wearable accessory device and/or the intermediary processing device may be configured to couple with the AR device 1100 via a coupling mechanism in electronic communication with a coupling sensor 1124, where the coupling sensor 1124 can detect when an electronic device becomes physically or electronically coupled with the AR device 1100. In some embodiments, the AR device 1100 can be configured to couple to a housing (e.g., a portion of frame 1104 or temple arms 1105), which may include one or more additional coupling mechanisms configured to couple with additional accessory devices. The components shown in FIG. 11A can be implemented in hardware, software, firmware, or a combination thereof, including one or more signal-processing components and/or application-specific integrated circuits (ASICs).

The AR device 1100 includes mechanical glasses components, including a frame 1104 configured to hold one or more lenses (e.g., one or both lenses 1106-1 and 1106-2). One of ordinary skill in the art will appreciate that the AR device 1100 can include additional mechanical components, such as hinges configured to allow portions of the frame 1104 of the AR device 1100 to be folded and unfolded, a bridge configured to span the gap between the lenses 1106-1 and 1106-2 and rest on the user's nose, nose pads configured to rest on the bridge of the nose and provide support for the AR device 1100, earpieces configured to rest on the user's ears and provide additional support for the AR device 1100, temple arms 1105 configured to extend from the hinges to the earpieces of the AR device 1100, and the like. One of ordinary skill in the art will further appreciate that some examples of the AR device 1100 can include none of the mechanical components described herein. For example, smart contact lenses configured to present artificial-reality to users may not include any components of the AR device 1100.

The lenses 1106-1 and 1106-2 can be individual displays or display devices (e.g., a waveguide for projected representations). The lenses 1106-1 and 1106-2 may act together or independently to present an image or series of images to a user. In some embodiments, the lenses 1106-1 and 1106-2 can operate in conjunction with one or more display projector assemblies 1107A and 1107B to present image data to a user. While the AR device 1100 includes two displays, embodiments of this disclosure may be implemented in AR devices with a single near-eye display (NED) or more than two NEDs.

The AR device 1100 includes electronic components, many of which will be described in more detail below with respect to FIG. 11C. Some example electronic components are illustrated in FIG. 11A, including sensors 1123-1, 1123-2, 1123-3, 1123-4, 1123-5, and 1123-6, which can be distributed along a substantial portion of the frame 1104 of the AR device 1100. The different types of sensors are described below in reference to FIG. 11C. The AR device 1100 also includes a left camera 1139A and a right camera 1139B, which are located on different sides of the frame 1104. And the eyewear device includes one or more processors 1148A and 1148B (e.g., an integral microprocessor, such as an ASIC) that is embedded into a portion of the frame 1104.

FIGS. 11B-1 and 11B-2 show an example visual depiction of the VR device 1110 (e.g., a head-mounted display (HMD) 1112, also referred to herein as an artificial-reality headset, a head-wearable device, a VR headset, etc.). The HMD 1112 includes a front body 1114 and a frame 1116 (e.g., a strap or band) shaped to fit around a user's head. In some embodiments, the front body 1114 and/or the frame 1116 includes one or more electronic elements for facilitating presentation of and/or interactions with an AR and/or VR system (e.g., displays, processors (e.g., processor 1148A-1), IMUs, tracking emitter or detectors, sensors, etc.). In some embodiments, the HMD 1112 includes output audio transducers (e.g., an audio transducer 1118-1), as shown in FIG. 11B-2. In some embodiments, one or more components, such as the output audio transducer(s) 1118 and the frame 1116, can be configured to attach and detach (e.g., are detachably attachable) to the HMD 1112 (e.g., a portion or all of the frame 1116, and/or the output audio transducer 1118), as shown in FIG. 11B-2. In some embodiments, coupling a detachable component to the HMD 1112 causes the detachable component to come into electronic communication with the HMD 1112. The VR device 1110 includes electronic components, many of which will be described in more detail below with respect to FIG. 11C

FIG. 11B-1 to 11B-2 also show that the VR device 1110 one or more cameras, such as the left camera 1139A and the right camera 1139B, which can be analogous to the left and right cameras on the frame 1104 of the AR device 1100. In some embodiments, the VR device 1110 includes one or more additional cameras (e.g., cameras 1139C and 1139D), which can be configured to augment image data obtained by the cameras 1139A and 1139B by providing more information. For example, the camera 1139C can be used to supply color information that is not discerned by cameras 1139A and 1139B. In some embodiments, one or more of the cameras 1139A to 1139D can include an optional IR cut filter configured to remove IR light from being received at the respective camera sensors.

The VR device 1110 can include a housing 1190 storing one or more components of the VR device 1110 and/or additional components of the VR device 1110. The housing 1190 can be a modular electronic device configured to couple with the VR device 1110 (or an AR device 1100) and supplement and/or extend the capabilities of the VR device 1110 (or an AR device 1100). For example, the housing 1190 can include additional sensors, cameras, power sources, processors (e.g., processor 1148A-2), etc. to improve and/or increase the functionality of the VR device 1110. Examples of the different components included in the housing 1190 are described below in reference to FIG. 11C.

Alternatively or in addition, in some embodiments, the head-wearable device, such as the VR device 1110 and/or the AR device 1100), includes, or is communicatively coupled to, another external device (e.g., a paired device), such as an HIPD 12 (discussed below in reference to FIGS. 12A-12B) and/or an optional neckband. The optional neckband can couple to the head-wearable device via one or more connectors (e.g., wired or wireless connectors). The head-wearable device and the neckband can operate independently without any wired or wireless connection between them. In some embodiments, the components of the head-wearable device and the neckband are located on one or more additional peripheral devices paired with the head-wearable device, the neckband, or some combination thereof. Furthermore, the neckband is intended to represent any suitable type or form of paired device. Thus, the following discussion of neckband may also apply to various other paired devices, such as smart watches, smart phones, wrist bands, other wearable devices, hand-held controllers, tablet computers, or laptop computers.

In some situations, pairing external devices, such as an intermediary processing device (e.g., an HIPD device 1200, an optional neckband, and/or wearable accessory device) with the head-wearable devices (e.g., an AR device 1100 and/or VR device 1110) enables the head-wearable devices to achieve a similar form factor of a pair of glasses while still providing sufficient battery and computation power for expanded capabilities. Some, or all, of the battery power, computational resources, and/or additional features of the head-wearable devices can be provided by a paired device or shared between a paired device and the head-wearable devices, thus reducing the weight, heat profile, and form factor of the head-wearable devices overall while allowing the head-wearable devices to retain its desired functionality. For example, the intermediary processing device (e.g., the HIPD 1200) can allow components that would otherwise be included in a head-wearable device to be included in the intermediary processing device (and/or a wearable device or accessory device), thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on the head-wearable devices, standing alone. Because weight carried in the intermediary processing device can be less invasive to a user than weight carried in the head-wearable devices, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

In some embodiments, the intermediary processing device is communicatively coupled with the head-wearable device and/or to other devices. The other devices may provide certain functions (e.g., tracking, localizing, depth mapping, processing, storage, etc.) to the head-wearable device. In some embodiments, the intermediary processing device includes a controller and a power source. In some embodiments, sensors of the intermediary processing device are configured to sense additional data that can be shared with the head-wearable devices in an electronic format (analog or digital).

The controller of the intermediary processing device processes information generated by the sensors on the intermediary processing device and/or the head-wearable devices. The intermediary processing device, like an HIPD 1200, can process information generated by one or more sensors of its sensors and/or information provided by other communicatively coupled devices. For example, a head-wearable device can include an IMU, and the intermediary processing device (neckband and/or an HIPD 1200) can compute all inertial and spatial calculations from the IMUs located on the head-wearable device. Additional examples of processing performed by a communicatively coupled device, such as the HIPD 1200, are provided below in reference to FIGS. 12A and 12B.

Artificial-reality systems may include a variety of types of visual feedback mechanisms. For example, display devices in the AR devices 1100 and/or the VR devices 1110 may include one or more liquid-crystal displays (LCDs), light emitting diode (LED) displays, organic LED (OLED) displays, and/or any other suitable type of display screen. Artificial-reality systems may include a single display screen for both eyes or may provide a display screen for each eye, which may allow for additional flexibility for varifocal adjustments or for correcting a refractive error associated with the user's vision. Some artificial-reality systems also include optical subsystems having one or more lenses (e.g., conventional concave or convex lenses, Fresnel lenses, or adjustable liquid lenses) through which a user may view a display screen. In addition to or instead of using display screens, some artificial-reality systems include one or more projection systems. For example, display devices in the AR device 1100 and/or the VR device 1110 may include micro-LED projectors that project light (e.g., using a waveguide) into display devices, such as clear combiner lenses that allow ambient light to pass through. The display devices may refract the projected light toward a user's pupil and may enable a user to simultaneously view both artificial-reality content and the real world. Artificial-reality systems may also be configured with any other suitable type or form of image projection system. As noted, some AR systems may, instead of blending an artificial reality with actual reality, substantially replace one or more of a user's sensory perceptions of the real world with a virtual experience.

While the example head-wearable devices are respectively described herein as the AR device 1100 and the VR device 1110, either or both of the example head-wearable devices described herein can be configured to present fully-immersive VR scenes presented in substantially all of a user's field of view, additionally or alternatively to, subtler augmented-reality scenes that are presented within a portion, less than all, of the user's field of view.

In some embodiments, the AR device 1100 and/or the VR device 1110 can include haptic feedback systems. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback can be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices (e.g., wrist-wearable devices which may be incorporated into headwear, gloves, body suits, handheld controllers, environmental devices (e.g., chairs or floormats), and/or any other type of device or system, such as a wrist-wearable device 1000, an HIPD 1200, and/or other devices described herein.

FIG. 11C illustrates a computing system 1120 and an optional housing 1190, each of which show components that can be included in a head-wearable device (e.g., the AR device 1100 and/or the VR device 1110). In some embodiments, more or less components can be included in the optional housing 1190 depending on practical restraints of the respective head-wearable device being described. Additionally or alternatively, the optional housing 1190 can include additional components to expand and/or augment the functionality of a head-wearable device.

In some embodiments, the computing system 1120 and/or the optional housing 1190 can include one or more peripheral interfaces 1122A and 1122B, one or more power systems 1142A and 1142B (including charger input 1143, PMIC 1144, and battery 1145), one or more controllers 1146A 1146B (including one or more haptic controllers 1147), one or more processors 1148A and 1148B (as defined above, including any of the examples provided), and memory 1150A and 1150B, which can all be in electronic communication with each other. For example, the one or more processors 1148A and/or 1148B can be configured to execute instructions stored in the memory 1150A and/or 1150B, which can cause a controller of the one or more controllers 1146A and/or 1146B to cause operations to be performed at one or more peripheral devices of the peripherals interfaces 1122A and/or 1122B. In some embodiments, each operation described can occur based on electrical power provided by the power system 1142A and/or 1142B.

In some embodiments, the peripherals interface 1122A can include one or more devices configured to be part of the computing system 1120, many of which have been defined above and/or described with respect to wrist-wearable devices shown in FIGS. 10A and 10B. For example, the peripherals interface can include one or more sensors 1123A. Some example sensors include: one or more coupling sensors 1124, one or more acoustic sensors 1125, one or more imaging sensors 1126, one or more EMG sensors 1127, one or more capacitive sensors 1128, and/or one or more IMUs 1129. In some embodiments, the sensors 1123A further include depth sensors 1167, light sensors 1168 and/or any other types of sensors defined above or described with respect to any other embodiments discussed herein.

In some embodiments, the peripherals interface can include one or more additional peripheral devices, including one or more NFC devices 1130, one or more GPS devices 1131, one or more LTE devices 1132, one or more WiFi and/or Bluetooth devices 1133, one or more buttons 1134 (e.g., including buttons that are slidable or otherwise adjustable), one or more displays 1135A, one or more speakers 1136A, one or more microphones 1137A, one or more cameras 1138A (e.g., including the a first camera 1139-1 through nth camera 1139-n, which are analogous to the left camera 1139A and/or the right camera 1139B), one or more haptic devices 1140; and/or any other types of peripheral devices defined above or described with respect to any other embodiments discussed herein.

The head-wearable devices can include a variety of types of visual feedback mechanisms (e.g., presentation devices). For example, display devices in the AR device 1100 and/or the VR device 1110 can include one or more liquid-crystal displays (LCDs), light emitting diode (LED) displays, organic LED (OLED) displays, micro-LEDs, and/or any other suitable types of display screens. The head-wearable devices can include a single display screen (e.g., configured to be seen by both eyes), and/or can provide separate display screens for each eye, which can allow for additional flexibility for varifocal adjustments and/or for correcting a refractive error associated with the user's vision. Some embodiments of the head-wearable devices also include optical subsystems having one or more lenses (e.g., conventional concave or convex lenses, Fresnel lenses, or adjustable liquid lenses) through which a user can view a display screen. For example, respective displays 1135A can be coupled to each of the lenses 1106-1 and 1106-2 of the AR device 1100. The displays 1135A coupled to each of the lenses 1106-1 and 1106-2 can act together or independently to present an image or series of images to a user. In some embodiments, the AR device 1100 and/or the VR device 1110 includes a single display 1135A (e.g., a near-eye display) or more than two displays 1135A.

In some embodiments, a first set of one or more displays 1135A can be used to present an augmented-reality environment, and a second set of one or more display devices 1135A can be used to present a virtual-reality environment. In some embodiments, one or more waveguides are used in conjunction with presenting artificial-reality content to the user of the AR device 1100 and/or the VR device 1110 (e.g., as a means of delivering light from a display projector assembly and/or one or more displays 1135A to the user's eyes). In some embodiments, one or more waveguides are fully or partially integrated into the AR device 1100 and/or the VR device 1110. Additionally, or alternatively to display screens, some artificial-reality systems include one or more projection systems. For example, display devices in the AR device 1100 and/or the VR device 1110 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. The head-wearable devices can also be configured with any other suitable type or form of image projection system. In some embodiments, one or more waveguides are provided additionally or alternatively to the one or more display(s) 1135A.

In some embodiments of the head-wearable devices, ambient light and/or a real-world live view (e.g., a live feed of the surrounding environment that a user would normally see) can be passed through a display element of a respective head-wearable device presenting aspects of the AR system. In some embodiments, ambient light and/or the real-world live view can be passed through a portion less than all, of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable devices, and an amount of ambient light and/or the real-world live view (e.g., 15-50% of the ambient light and/or the real-world live view) can be passed through the user interface element, such that the user can distinguish at least a portion of the physical environment over which the user interface element is being displayed.

The head-wearable devices can include one or more external displays 1135A for presenting information to users. For example, an external display 1135A can be used to show a current battery level, network activity (e.g., connected, disconnected, etc.), current activity (e.g., playing a game, in a call, in a meeting, watching a movie, etc.), and/or other relevant information. In some embodiments, the external displays 1135A can be used to communicate with others. For example, a user of the head-wearable device can cause the external displays 1135A to present a do not disturb notification. The external displays 1135A can also be used by the user to share any information captured by the one or more components of the peripherals interface 1122A and/or generated by head-wearable device (e.g., during operation and/or performance of one or more applications).

The memory 1150A can include instructions and/or data executable by one or more processors 1148A (and/or processors 1148B of the housing 1190) and/or a memory controller of the one or more controllers 1146A (and/or controller 1146B of the housing 1190). The memory 1150A can include one or more operating systems 1151; one or more applications 1152; one or more communication interface modules 1153A; one or more graphics modules 1154A; one or more AR processing modules 1155A; calibration module 1156 (analogous to the calibration module 1086 described above in reference to FIG. 10B) for performing the operations described above in reference to FIGS. 1A-8; and/or any other types of modules or components defined above or described with respect to any other embodiments discussed herein.

The data 1160 stored in memory 1150A can be used in conjunction with one or more of the applications and/or programs discussed above. The data 1160 can include profile data 1161; sensor data 1162; media content data 1163; AR application data 1164; calibration data 1165 (analogous to the calibration module 1092 described above in reference to FIG. 10B) for storing data related to the performance of the operations described above in reference to FIGS. 1A-8; and/or any other types of data defined above or described with respect to any other embodiments discussed herein.

In some embodiments, the controller 1146A of the head-wearable devices processes information generated by the sensors 1123A on the head-wearable devices and/or another component of the head-wearable devices and/or communicatively coupled with the head-wearable devices (e.g., components of the housing 1190, such as components of peripherals interface 1122B). For example, the controller 1146A can process information from the acoustic sensors 1125 and/or image sensors 1126. For each detected sound, the controller 1146A can perform a direction of arrival (DOA) estimation to estimate a direction from which the detected sound arrived at a head-wearable device. As one or more of the acoustic sensors 1125 detects sounds, the controller 1146A can populate an audio data set with the information (e.g., represented by sensor data 1162).

In some embodiments, a physical electronic connector can convey information between the head-wearable devices and another electronic device, and/or between one or more processors 1148A of the head-wearable devices and the controller 1146A. The information can be in the form of optical data, electrical data, wireless data, or any other transmittable data form. Moving the processing of information generated by the head-wearable devices to an intermediary processing device can reduce weight and heat in the eyewear device, making it more comfortable and safer for a user. In some embodiments, an optional accessory device (e.g., an electronic neckband or an HIPD 1200) is coupled to the head-wearable devices via one or more connectors. The connectors can be wired or wireless connectors and can include electrical and/or non-electrical (e.g., structural) components. In some embodiments, the head-wearable devices and the accessory device can operate independently without any wired or wireless connection between them.

The head-wearable devices can include various types of computer vision components and subsystems. For example, the AR device 1100 and/or the VR device 1110 can include one or more optical sensors such as two-dimensional (2D) or three-dimensional (3D) cameras, time-of-flight depth sensors, single-beam or sweeping laser rangefinders, 3D LiDAR sensors, and/or any other suitable type or form of optical sensor. A head-wearable device can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate interactable virtual objects (which can be replicas or digital twins of real-world objects that can be interacted with in AR environment), among a variety of other functions. For example, FIGS. 11B-1 and 11B-2 show the VR device 1110 having cameras 1139A-1139D, which can be used to provide depth information for creating a voxel field and a two-dimensional mesh to provide object information to the user to avoid collisions.

The optional housing 1190 can include analogous components to those describe above with respect to the computing system 1120. For example, the optional housing 1190 can include a respective peripherals interface 1122B including more or less components to those described above with respect to the peripherals interface 1122A. As described above, the components of the optional housing 1190 can be used augment and/or expand on the functionality of the head-wearable devices. For example, the optional housing 1190 can include respective sensors 1123B, speakers 1136B, displays 1135B, microphones 1137B, cameras 1138B, and/or other components to capture and/or present data. Similarly, the optional housing 1190 can include one or more processors 1148B, controllers 1146B, and/or memory 1150B (including respective communication interface modules 1153B; one or more graphics modules 1154B; one or more AR processing modules 1155B, calibration module 1156, calibration data 1165, etc.) that can be used individually and/or in conjunction with the components of the computing system 1120.

The techniques described above in FIGS. 11A-11C can be used with different head-wearable devices. In some embodiments, the head-wearable devices (e.g., the AR device 1100 and/or the VR device 1110) can be used in conjunction with one or more wearable device such as a wrist-wearable device 1000 (or components thereof) and/or an HIPD 1200. Having thus described example the head-wearable devices, attention will now be turned to example handheld intermediary processing devices, such as HIPD 1200.

### Example Handheld Intermediary Processing Devices

FIGS. 12A and 12B illustrate an example handheld intermediary processing device (HIPD) 1200, in accordance with some embodiments. The HIPD 1200 can be a variation of a storage device or case 102 described in reference to FIGS. 1A-8 herein, such that the HIPD 1200 should be understood to have the features described with respect to any intermediary device defined above or otherwise described herein, and vice versa. The HIPD 1200 can perform various functions and/or operations associated with navigating through user interfaces and selectively opening applications, as well as the functions and/or operations described above with reference to FIGS. 1A-8. Although the HIPD is described as a variation of case 102, it should be noted that the case 102 can be an independent device that is associate with a respective head-wearable device.

FIG. 12A shows a top view 1205 and a side view 1225 of the HIPD 1200. The HIPD 1200 is configured to communicatively couple with one or more wearable devices (or other electronic devices) associated with a user. For example, the HIPD 1200 is configured to communicatively couple with a user's wrist-wearable device 1000 (or components thereof, such as the watch body 1020 and the wearable band 1010), AR device 1100, and/or VR device 1110. The HIPD 1200 can be configured to be held by a user (e.g., as a handheld controller), carried on the user's person (e.g., in their pocket, in their bag, etc.), placed in proximity of the user (e.g., placed on their desk while seated at their desk, on a charging dock, etc.), and/or placed at or within a predetermined distance from a wearable device or other electronic device (e.g., where, in some embodiments, the predetermined distance is the maximum distance (e.g., 10 meters) at which the HIPD 1200 can successfully be communicatively coupled with an electronic device, such as a wearable device).

The HIPD 1200 can perform various functions independently and/or in conjunction with one or more wearable devices (e.g., wrist-wearable device 1000, AR device 1100, VR device 1110, etc.). The HIPD 1200 is configured to increase and/or improve the functionality of communicatively coupled devices, such as the wearable devices. The HIPD 1200 is configured to perform one or more functions or operations associated with interacting with user interfaces and applications of communicatively coupled devices, interacting with an AR environment, interacting with VR environment, and/or operating as a human-machine interface controller, as well as functions and/or operations described above with reference to FIGS. 1A-8. Additionally, as will be described in more detail below, functionality and/or operations of the HIPD 1200 can include, without limitation, task offloading and/or handoffs; thermals offloading and/or handoffs; 6 degrees of freedom (6DoF) raycasting and/or gaming (e.g., using imaging devices or cameras 1214A and 1214B, which can be used for simultaneous localization and mapping (SLAM) and/or with other image processing techniques); portable charging; messaging; image capturing via one or more imaging devices or cameras (e.g., cameras 1222A and 1222B); sensing user input (e.g., sensing a touch on a multi-touch input surface 1202); wireless communications and/or interlining (e.g., cellular, near field, Wi-Fi, personal area network, etc.); location determination; financial transactions; providing haptic feedback; alarms; notifications; biometric authentication; health monitoring; sleep monitoring; etc. The above-example functions can be executed independently in the HIPD 1200 and/or in communication between the HIPD 1200 and another wearable device described herein. In some embodiments, functions can be executed on the HIPD 1200 in conjunction with an AR environment. As the skilled artisan will appreciate upon reading the descriptions provided herein, the novel the HIPD 1200 described herein can be used with any type of suitable AR environment.

While the HIPD 1200 is communicatively coupled with a wearable device and/or other electronic device, the HIPD 1200 is configured to perform one or more operations initiated at the wearable device and/or the other electronic device. In particular, one or more operations of the wearable device and/or the other electronic device can be offloaded to the HIPD 1200 to be performed. The HIPD 1200 performs the one or more operations of the wearable device and/or the other electronic device and provides to data corresponded to the completed operations to the wearable device and/or the other electronic device. For example, a user can initiate a video stream using AR device 1100 and back-end tasks associated with performing the video stream (e.g., video rendering) can be offloaded to the HIPD 1200, which the HIPD 1200 performs and provides corresponding data to the AR device 1100 to perform remaining front-end tasks associated with the video stream (e.g., presenting the rendered video data via a display of the AR device 1100). In this way, the HIPD 1200, which has more computational resources and greater thermal headroom than a wearable device, can perform computationally intensive tasks for the wearable device improving performance of an operation performed by the wearable device.

The HIPD 1200 includes a multi-touch input surface 1202 on a first side (e.g., a front surface) that is configured to detect one or more user inputs. In particular, the multi-touch input surface 1202 can detect single tap inputs, multi-tap inputs, swipe gestures and/or inputs, force-based and/or pressure-based touch inputs, held taps, and the like. The multi-touch input surface 1202 is configured to detect capacitive touch inputs and/or force (and/or pressure) touch inputs. The multi-touch input surface 1202 includes a first touch-input surface 1204 defined by a surface depression, and a second touch-input surface 1206 defined by a substantially planar portion. The first touch-input surface 1204 can be disposed adjacent to the second touch-input surface 1206. In some embodiments, the first touch-input surface 1204 and the second touch-input surface 1206 can be different dimensions, shapes, and/or cover different portions of the multi-touch input surface 1202. For example, the first touch-input surface 1204 can be substantially circular and the second touch-input surface 1206 is substantially rectangular. In some embodiments, the surface depression of the multi-touch input surface 1202 is configured to guide user handling of the HIPD 1200. In particular, the surface depression is configured such that the user holds the HIPD 1200 upright when held in a single hand (e.g., such that the using imaging devices or cameras 1214A and 1214B are pointed toward a ceiling or the sky). Additionally, the surface depression is configured such that the user's thumb rests within the first touch-input surface 1204.

In some embodiments, the different touch-input surfaces include a plurality of touch-input zones. For example, the second touch-input surface 1206 includes at least a first touch-input zone 1208 within a second touch-input zone 1206 and a third touch-input zone 1210 within the first touch-input zone 1208. In some embodiments, one or more of the touch-input zones are optional and/or user defined (e.g., a user can specific a touch-input zone based on their preferences). In some embodiments, each touch-input surface and/or touch-input zone is associated with a predetermined set of commands. For example, a user input detected within the first touch-input zone 1208 causes the HIPD 1200 to perform a first command and a user input detected within the second touch-input zone 1206 causes the HIPD 1200 to perform a second command, distinct from the first. In some embodiments, different touch-input surfaces and/or touch-input zones are configured to detect one or more types of user inputs. The different touch-input surfaces and/or touch-input zones can be configured to detect the same or distinct types of user inputs. For example, the first touch-input zone 1208 can be configured to detect force touch inputs (e.g., a magnitude at which the user presses down) and capacitive touch inputs, and the second touch-input zone 1206 can be configured to detect capacitive touch inputs.

The HIPD 1200 includes one or more sensors 1251 for sensing data used in the performance of one or more operations and/or functions. For example, the HIPD 1200 can include an IMU that is used in conjunction with cameras 1214 for 3-dimensional object manipulation (e.g., enlarging, moving, destroying, etc. an object) in an AR or VR environment. Non-limiting examples of the sensors 1251 included in the HIPD 1200 include a light sensor, a magnetometer, a depth sensor, a pressure sensor, and a force sensor. Additional examples of the sensors 1251 are provided below in reference to FIG. 12B.

The HIPD 1200 can include one or more light indicators 1212 to provide one or more notifications to the user. In some embodiments, the light indicators are LEDs or other types of illumination devices. The light indicators 1212 can operate as a privacy light to notify the user and/or others near the user that an imaging device and/or microphone are active. In some embodiments, a light indicator is positioned adjacent to one or more touch-input surfaces. For example, a light indicator can be positioned around the first touch-input surface 1204. The light indicators can be illuminated in different colors and/or patterns to provide the user with one or more notifications and/or information about the device. For example, a light indicator positioned around the first touch-input surface 1204 can flash when the user receives a notification (e.g., a message), change red when the HIPD 1200 is out of power, operate as a progress bar (e.g., a light ring that is closed when a task is completed (e.g., 0% to 100%)), operates as a volume indicator, etc.).

In some embodiments, the HIPD 1200 includes one or more additional sensors on another surface. For example, as shown FIG. 12A, HIPD 1200 includes a set of one or more sensors (e.g., sensor set 1220) on an edge of the HIPD 1200. The sensor set 1220, when positioned on an edge of the of the HIPD 1200, can be pe positioned at a predetermined tilt angle (e.g., 26 degrees), which allows the sensor set 1220 to be angled toward the user when placed on a desk or other flat surface. Alternatively, in some embodiments, the sensor set 1220 is positioned on a surface opposite the multi-touch input surface 1202 (e.g., a back surface). The one or more sensors of the sensor set 1220 are discussed in detail below.

The side view 1225 of the of the HIPD 1200 shows the sensor set 1220 and camera 1214B. The sensor set 1220 includes one or more cameras 1222A and 1222B, a depth projector 1224, an ambient light sensor 1228, and a depth receiver 1230. In some embodiments, the sensor set 1220 includes a light indicator 1226. The light indicator 1226 can operate as a privacy indicator to let the user and/or those around them know that a camera and/or microphone is active. The sensor set 1220 is configured to capture a user's facial expression such that the user can puppet a custom avatar (e.g., showing emotions, such as smiles, laughter, etc., on the avatar or a digital representation of the user). The sensor set 1220 can be configured as a side stereo RGB system, a rear indirect Time-of-Flight (iToF) system, or a rear stereo RGB system. As the skilled artisan will appreciate upon reading the descriptions provided herein, the novel HIPD 1200 described herein can use different sensor set 1220 configurations and/or sensor set 1220 placement.

In some embodiments, the HIPD 1200 includes one or more haptic devices 1271 (FIG. 12B; e.g., a vibratory haptic actuator) that are configured to provide haptic feedback (e.g., kinesthetic sensation). The sensors 1251, and/or the haptic devices 1271 can be configured to operate in conjunction with multiple applications and/or communicatively coupled devices including, without limitation, a wearable devices, health monitoring applications, social media applications, game applications, and artificial reality applications (e.g., the applications associated with artificial reality).

The HIPD 1200 is configured to operate without a display. However, in optional embodiments, the HIPD 1200 can include a display 1268 (FIG. 12B). The HIPD 1200 can also income one or more optional peripheral buttons 1267 (FIG. 12B). For example, the peripheral buttons 1267 can be used to turn on or turn off the HIPD 1200. Further, the HIPD 1200 housing can be formed of polymers and/or elastomer elastomers. The HIPD 1200 can be configured to have a non-slip surface to allow the HIPD 1200 to be placed on a surface without requiring a user to watch over the HIPD 1200. In other words, the HIPD 1200 is designed such that it would not easily slide off a surfaces. In some embodiments, the HIPD 1200 include one or magnets to couple the HIPD 1200 to another surface. This allows the user to mount the HIPD 1200 to different surfaces and provide the user with greater flexibility in use of the HIPD 1200.

As described above, the HIPD 1200 can distribute and/or provide instructions for performing the one or more tasks at the HIPD 1200 and/or a communicatively coupled device. For example, the HIPD 1200 can identify one or more back-end tasks to be performed by the HIPD 1200 and one or more front-end tasks to be performed by a communicatively coupled device. While the HIPD 1200 is configured to offload and/or handoff tasks of a communicatively coupled device, the HIPD 1200 can perform both back-end and front-end tasks (e.g., via one or more processors, such as CPU 1277; FIG. 12B). The HIPD 1200 can, without limitation, can be used to perform augmenting calling (e.g., receiving and/or sending 3D or 2.5D live volumetric calls, live digital human representation calls, and/or avatar calls), discreet messaging, 6DoF portrait/landscape gaming, AR/VR object manipulation, AR/VR content display (e.g., presenting content via a virtual display), and/or other AR/VR interactions. The HIPD 1200 can perform the above operations alone or in conjunction with a wearable device (or other communicatively coupled electronic device).

FIG. 12B shows block diagrams of a computing system 1240 of the HIPD 1200, in accordance with some embodiments. The HIPD 1200, described in detail above, can include one or more components shown in HIPD computing system 1240. The HIPD 1200 will be understood to include the components shown and described below for the HIPD computing system 1240. In some embodiments, all, or a substantial portion of the components of the HIPD computing system 1240 are included in a single integrated circuit. Alternatively, in some embodiments, components of the HIPD computing system 1240 are included in a plurality of integrated circuits that are communicatively coupled.

The HIPD computing system 1240 can include a processor (e.g., a CPU 1277, a GPU, and/or a CPU with integrated graphics), a controller 1275, a peripherals interface 1250 that includes one or more sensors 1251 and other peripheral devices, a power source (e.g., a power system 1295), and memory (e.g., a memory 1278) that includes an operating system (e.g., an operating system 1279), data (e.g., data 1288), one or more applications (e.g., applications 1280), and one or more modules (e.g., a communications interface module 1281, a graphics module 1282, a task and processing management module 1283, an interoperability module 1284, an AR processing module 1285, a data management module 1286, a calibration module 1287, etc.). The HIPD computing system 1240 further includes a power system 1295 that includes a charger input and output 1296, a PMIC 1297, and a battery 1298, all of which are defined above.

In some embodiments, the peripherals interface 1250 can include one or more sensors 1251. The sensors 1251 can include analogous sensors to those described above in reference to FIG. 10B. For example, the sensors 1251 can include imaging sensors 1254, (optional) EMG sensors 1256, IMUs 1258, and capacitive sensors 1260. In some embodiments, the sensors 1251 can include one or more pressure sensor 1252 for sensing pressure data, an altimeter 1253 for sensing an altitude of the HIPD 1200, a magnetometer 1255 for sensing a magnetic field, a depth sensor 1257 (or a time-of flight sensor) for determining a difference between the camera and the subject of an image, a position sensor 1259 (e.g., a flexible position sensor) for sensing a relative displacement or position change of a portion of the HIPD 1200, a force sensor 1261 for sensing a force applied to a portion of the HIPD 1200, and a light sensor 1262 (e.g., an ambient light sensor) for detecting an amount of lighting. The sensors 1251 can include one or more sensors not shown in FIG. 12B.

Analogous to the peripherals described above in reference to FIGS. 10B, the peripherals interface 1250 can also include an NFC component 1263, a GPS component 1264, an LTE component 1265, a Wi-Fi and/or Bluetooth communication component 1266, a speaker 1269, a haptic device 1271, and a microphone 1273. As described above in reference to FIG. 12A, the HIPD 1200 can optionally include a display 1268 and/or one or more buttons 1267. The peripherals interface 1250 can further include one or more cameras 1270, touch surfaces 1272, and/or one or more light emitters 1274. The multi-touch input surface 1202 described above in reference to FIG. 12A is an example of touch surface 1272. The light emitters 1274 can be one or more LEDs, lasers, etc. and can be used to project or present information to a user. For example, the light emitters 1274 can include light indicators 1212 and 1226 described above in reference to FIG. 12A. The cameras 1270 (e.g., cameras 1214A, 1214B, and 1222 described above in FIG. 12A) can include one or more wide angle cameras, fish-eye cameras, spherical cameras, compound eye cameras (e.g., stereo and multi cameras), depth cameras, RGB cameras, ToF cameras, RGB-D cameras (depth and ToF cameras), and/or other available cameras. Cameras 1270 can be used for SLAM; 6 DoF ray casting, gaming, object manipulation, and/or other rendering; facial recognition and facial expression recognition, etc.

Similar to the watch body computing system 1060 and the watch band computing system 1030 described above in reference to FIG. 10B, the HIPD computing system 1240 can include one or more haptic controllers 1276 and associated componentry (e.g., haptic devices 1271) for providing haptic events at the HIPD 1200.

Memory 1278 can include high-speed random-access memory and/or non-volatile memory, such as one or more magnetic disk storage devices, flash memory devices, or other non-volatile solid-state memory devices. Access to the memory 1278 by other components of the HIPD 1200, such as the one or more processors and the peripherals interface 1250, can be controlled by a memory controller of the controllers 1275.

In some embodiments, software components stored in the memory 1278 include one or more operating systems 1279, one or more applications 1280, one or more communication interface modules 1281, one or more graphics modules 1282, one or more data management modules 1285, which are analogous to the software components described above in reference to FIG. 10B. The software components stored in the memory 1278 can also include a calibration module 1287 (analogous to the calibration module 1086 described above in reference to FIG. 10B) for performing the operations described above in reference to FIGS. 1A-8.

In some embodiments, software components stored in the memory 1278 include a task and processing management module 1283 for identifying one or more front-end and back-end tasks associated with an operation performed by the user, performing one or more front-end and/or back-end tasks, and/or providing instructions to one or more communicatively coupled devices that cause performance of the one or more front-end and/or back-end tasks. In some embodiments, the task and processing management module 1283 uses data 1288 (e.g., device data 1290) to distribute the one or more front-end and/or back-end tasks based on communicatively coupled devices' computing resources, available power, thermal headroom, ongoing operations, and/or other factors. For example, the task and processing management module 1283 can cause the performance of one or more back-end tasks (of an operation performed at communicatively coupled AR device 1100) at the HIPD 1200 in accordance with a determination that the operation is utilizing a predetermined amount (e.g., at least 70%) of computing resources available at the AR device 1100.

In some embodiments, software components stored in the memory 1278 include an interoperability module 1284 for exchanging and utilizing information received and/or provided to distinct communicatively coupled devices. The interoperability module 1284 allows for different systems, devices, and/or applications to connect and communicate in a coordinated way without user input. In some embodiments, software components stored in the memory 1278 include an AR module 1285 that is configured to process signals based at least on sensor data for use in an AR and/or VR environment. For example, the AR processing module 1285 can be used for 3D object manipulation, gesture recognition, facial and facial expression, recognition, etc.

The memory 1278 can also include data 1287, including structured data. In some embodiments, the data 1287 can include profile data 1289, device data 1289 (including device data of one or more devices communicatively coupled with the HIPD 1200, such as device type, hardware, software, configurations, etc.), sensor data 1291, media content data 1292, application data 1293, and calibration data 1294 (analogous to the calibration module 1092 described above in reference to FIG. 10B), which stores data related to the performance of the operations described above in reference to FIGS. 1A-8.

It should be appreciated that the HIPD computing system 1240 is an example of a computing system within the HIPD 1200, and that the HIPD 1200 can have more or fewer components than shown in the HIPD computing system 1240, combine two or more components, and/or have a different configuration and/or arrangement of the components. The various components shown in HIPD computing system 1240 are implemented in hardware, software, firmware, or a combination thereof, including one or more signal processing and/or application-specific integrated circuits.

The techniques described above in FIG. 12A-12B can be used with any device used as a human-machine interface controller. In some embodiments, an HIPD 1200 can be used in conjunction with one or more wearable device such as a head-wearable device (e.g., AR device 1100 and VR device 1110) and/or a wrist-wearable device 1000 (or components thereof).

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt-in or opt-out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A non-transitory computer readable storage medium storing one or more programs, the one or more programs comprising instructions that, when executed by artificial-reality glasses that are in communication with a storage device for the artificial-reality glasses, cause the artificial-reality glasses to:
while a position of the artificial-reality glasses relative to the storage device satisfies relative position criteria:
cause the artificial-reality glasses to display one or more calibration patterns using a first lens assembly and a second lens assembly of the artificial-reality glasses, and
capture, using one or more imaging devices communicatively coupled to the storage device and associated with the first lens assembly and the second lens assembly, one or more calibration images of the one or more calibration patterns displayed using the first lens assembly and the second lens assembly of the artificial-reality glasses;
in accordance with a determination, based on the one or more calibration images, that an amount of disparity between the respective calibration patterns displayed using the first lens assembly and the second lens assembly satisfies calibration criteria:
cause the artificial-reality glasses to apply, based on the amount of disparity, a disparity correction to one or both of the first lens assembly and the second lens assembly.

2. The non-transitory computer readable storage medium of claim 1, wherein:
the amount of disparity is determined based on a pixel-level difference between a first calibration image of the one or more calibration images and a second calibration image of the one or more calibration images, wherein the first calibration image is associated with the first lens assembly and the second calibration is associated with the second lens assembly; and
the instructions that, when executed by the artificial-reality glasses, also cause the artificial-reality glasses to determine based on the pixel-level difference between the first calibration image and the second calibration image, the disparity correction, wherein the disparity correction reduces the pixel-level difference between the first calibration image and the second calibration image.

3. The non-transitory computer readable storage medium of claim 1, wherein the causing the artificial-reality glasses to apply, based on the amount of disparity, the disparity correction to one or both of the first lens assembly and the second lens assembly includes:
causing the artificial-reality glasses to apply the disparity correction to one or more images prior to displaying the one or more images using the first lens assembly and the second lens assembly.

4. The non-transitory computer readable storage medium of claim 1, wherein:
the artificial-reality glasses displays the one or more calibration patterns using a first projector assembly associated with the first lens assembly and a second project assembly associated with the second lens assembly; and
the causing the artificial-reality glasses to apply, based on the amount of disparity, the disparity correction to one or both of the first lens assembly and the second lens assembly includes:
causing the artificial-reality glasses to modify a first image projection from the first projector assembly associated with the first lens assembly and/or a second image projection from the second project assembly associated with the second lens assembly to reduce the amount of disparity.

5. The non-transitory computer readable storage medium of claim 1, wherein the amount of disparity is a first amount of disparity, the disparity correction is a first disparity correction, and the instructions that, when executed by the artificial-reality glasses, also cause the artificial-reality glasses to:
in accordance with a determination that the artificial-reality glasses is being donned:
cause the artificial-reality glasses to capture deformation data regarding deformation of a frame of the artificial-reality glasses, wherein the deformation data includes at least deformation data before the artificial-reality glasses are donned and deformation data while the artificial-reality glasses are donned; and
in accordance with a determination, based on the deformation data, that a second amount of disparity while the artificial-reality glasses are donned satisfies the calibration criteria:
cause the artificial-reality glasses to apply, based on the second amount of disparity, a second disparity correction to one or both of the first lens assembly and the second lens assembly, wherein the second disparity correction is based on a difference between the deformation data before the artificial-reality glasses are donned and the deformation data while the artificial-reality glasses are donned such that the difference is reduced.

6. The non-transitory computer readable storage medium of claim 5, wherein:
the deformation data regarding the deformation of the frame of the artificial-reality glasses includes one or more images captured by the one or more imaging devices coupled to the frame of the artificial-reality glasses; and
the second amount of disparity is based on a difference between at least a first image of the one or more images before the artificial-reality glasses are donned and at least a second image of the one or more images while the artificial-reality glasses are donned.

7. The non-transitory computer readable storage medium of claim 5, wherein:
the data regarding the deformation of the frame of the artificial-reality glasses is captured by one or more force sensors coupled to the frame of the artificial-reality glasses, wherein the one or more force sensors are configured to detect deformation of the frame of the artificial-reality glasses; and
the amount of disparity is based on a change in measurements from the one or more force sensors before the artificial-reality glasses are donned and while the artificial-reality glasses are donned.

8. The non-transitory computer readable storage medium of claim 1, wherein:
a first imaging device of the one or more imaging devices is configured to capture the one or more calibration patterns displayed using the first lens assembly, wherein the first imaging device is positioned at a first region associated with the first lens assembly;
a second imaging device of the one or more imaging devices is configured to capture the one or more calibration patterns displayed using the second lens assembly, wherein the second imaging device is positioned at a second region associated with the second lens assembly; and
wherein:
the first region and the second region are a predefined distance apart, including a distance within an interpupillary distance range associated with the artificial-reality glasses; and
the first region and the second region are located proximate to a focal point associated with the first lens assembly and the second lens assembly, respectively.

9. The non-transitory computer readable storage medium of claim 8, wherein the first imaging device and the second imaging device are further positioned at a backplane associated with the storage device.

10. The non-transitory computer readable storage medium of claim 1, wherein:
the storage device includes:
a first optical element configured to redirect the one or more calibration patterns displayed using the first lens assembly towards an imaging device of the one or more imaging devices, and
a second optical element configured to redirect the one or more calibration patterns displayed using the second lens assembly towards the imaging device; and
the imaging device is configured to capture the one or more calibration patterns displayed using the first lens assembly and the second lens assembly that is redirected by the first optical and the second optical element, respectively.

11. The non-transitory computer readable storage medium of claim 1, wherein the instructions that, when executed by the artificial-reality glasses, also cause the artificial-reality glasses to:
capture, using the one or more imaging devices coupled to the storage device and associated with the first lens assembly and the second lens assembly, one or more calibration targets associated with the storage device; and
calibrating the one or more imaging devices using the one or more calibration targets.

12. The non-transitory computer readable storage medium of claim 1, wherein the instructions that, when executed by the artificial-reality glasses, also cause the artificial-reality glasses to:
in accordance with a determination, based on the one or more calibration images, that an amount of color disparity between the one or more calibration images and the respective calibration patterns satisfies color calibration criteria:
cause the artificial-reality glasses to apply, based on the amount of color disparity, a color disparity correction to one or both of the first lens assembly and the second lens assembly.

13. An artificial-reality glasses communicatively coupled with a storage device for the artificial-reality glasses, the artificial-reality glasses comprising:
a first lens assembly;
a second lens assembly; and
one or more programs, wherein the one or more programs are stored in memory and configured to be executed by one or more processors, the one or more programs including instructions for:
while a position of the artificial-reality glasses relative to the storage device satisfies relative position criteria:
causing the artificial-reality glasses to display one or more calibration patterns using a first lens assembly and a second lens assembly of the artificial-reality glasses, and
capturing, using one or more imaging devices communicatively coupled to the storage device and associated with the first lens assembly and the second lens assembly, one or more calibration images of the one or more calibration patterns displayed using the first lens assembly and the second lens assembly of the artificial-reality glasses;
in accordance with a determination, based on the one or more calibration images, that an amount of disparity between the respective calibration patterns displayed using the first lens assembly and the second lens assembly satisfies calibration criteria:
causing the artificial-reality glasses to apply, based on the amount of disparity, a disparity correction to one or both of the first lens assembly and the second lens assembly.

14. The artificial-reality glasses of claim 13, wherein:
the amount of disparity is determined based on a pixel-level difference between a first calibration image of the one or more calibration images and a second calibration image of the one or more calibration images, wherein the first calibration image is associated with the first lens assembly and the second calibration is associated with the second lens assembly; and
the instructions that, when executed by the artificial-reality glasses, also cause the artificial-reality glasses to determine based on the pixel-level difference between the first calibration image and the second calibration image, the disparity correction, wherein the disparity correction reduces the pixel-level difference between the first calibration image and the second calibration image.

15. The artificial-reality glasses of claim 13, wherein the causing the artificial-reality glasses to apply, based on the amount of disparity, the disparity correction to one or both of the first lens assembly and the second lens assembly includes:
causing the artificial-reality glasses to apply the disparity correction to one or more images prior to displaying the one or more images using the first lens assembly and the second lens assembly.

16. The artificial-reality glasses of claim 13, wherein:
the artificial-reality glasses displays the one or more calibration patterns using a first projector assembly associated with the first lens assembly and a second project assembly associated with the second lens assembly; and
the causing the artificial-reality glasses to apply, based on the amount of disparity, the disparity correction to one or both of the first lens assembly and the second lens assembly includes:
causing the artificial-reality glasses to modify a first image projection from the first projector assembly associated with the first lens assembly and/or a second image projection from the second project assembly associated with the second lens assembly to reduce the amount of disparity.

17. The artificial-reality glasses of claim 15, wherein the amount of disparity is a first amount of disparity, the disparity correction is a first disparity correction, and the one or more programs including instructions for:
in accordance with a determination that the artificial-reality glasses is being donned:
cause the artificial-reality glasses to capture deformation data regarding deformation of a frame of the artificial-reality glasses, wherein the deformation data includes at least deformation data before the artificial-reality glasses are donned and deformation data while the artificial-reality glasses are donned; and
in accordance with a determination, based on the deformation data, that a second amount of disparity while the artificial-reality glasses are donned satisfies the calibration criteria:
cause the artificial-reality glasses to apply, based on the second amount of disparity, a second disparity correction to one or both of the first lens assembly and the second lens assembly, wherein the second disparity correction is based on a difference between the deformation data before the artificial-reality glasses are donned and the deformation data while the artificial-reality glasses are donned such that the difference is reduced.

18. A method of disparity correction for an artificial-reality glasses, the method comprising:
while a position of the artificial-reality glasses relative to a storage device of the artificial-reality glasses satisfies relative position criteria:
causing the artificial-reality glasses to display one or more calibration patterns using a first lens assembly and a second lens assembly of the artificial-reality glasses, and
capturing, using one or more imaging devices communicatively coupled to the storage device and associated with the first lens assembly and the second lens assembly, one or more calibration images of the one or more calibration patterns displayed using the first lens assembly and the second lens assembly of the artificial-reality glasses;
in accordance with a determination, based on the one or more calibration images, that an amount of disparity between the respective calibration patterns displayed using the first lens assembly and the second lens assembly satisfies calibration criteria:
causing the artificial-reality glasses to apply, based on the amount of disparity, a disparity correction to one or both of the first lens assembly and the second lens assembly.

19. The method of claim 18, wherein:
the amount of disparity is determined based on a pixel-level difference between a first calibration image of the one or more calibration images and a second calibration image of the one or more calibration images, wherein the first calibration image is associated with the first lens assembly and the second calibration is associated with the second lens assembly; and
the instructions that, when executed by the artificial-reality glasses, also cause the artificial-reality glasses to determine based on the pixel-level difference between the first calibration image and the second calibration image, the disparity correction, wherein the disparity correction reduces the pixel-level difference between the first calibration image and the second calibration image.

20. The method of claim 18, wherein the amount of disparity is a first amount of disparity, the disparity correction is a first disparity correction, and the method includes:
in accordance with a determination that the artificial-reality glasses is being donned:
cause the artificial-reality glasses to capture deformation data regarding deformation of a frame of the artificial-reality glasses, wherein the deformation data includes at least deformation data before the artificial-reality glasses are donned and deformation data while the artificial-reality glasses are donned; and
in accordance with a determination, based on the deformation data, that a second amount of disparity while the artificial-reality glasses are donned satisfies the calibration criteria:
cause the artificial-reality glasses to apply, based on the second amount of disparity, a second disparity correction to one or both of the first lens assembly and the second lens assembly, wherein the second disparity correction is based on a difference between the deformation data before the artificial-reality glasses are donned and the deformation data while the artificial-reality glasses are donned such that the difference is reduced.
